(19) United States
(12) Patent Application Publication
(10) Pub. No.: US 2026/0303228 A1
(43) Pub. Date: Oct. 1, 2026

(54) DEVICE LOCALIZATION WITH CHANNEL SOUNDING AND PASSIVE SIGNALING

(71) Applicant: Texas Instruments Incorporated, Dallas, TX (US)

(72) Inventors: Jayson Paul Van Marter, Richardson, TX (US); Anand Ganesh Dabak, Plano, TX (US); Tomas Motos, Hamar (NO)

(21) Appl. No.: 19/277,045

(22) Filed: Jul. 22, 2025

Related U.S. Application Data
(60) Provisional application No. 63/779,706, filed on Mar. 28, 2025.

(51) Int. Cl. H04B 17/12; H04B 17/20; H04B 17/21

(52) U.S. Cl. CPC H04B 17/12; H04B 17/21; H04B 17/25

(57) ABSTRACT

An example apparatus includes: an initiator device configurable to: transmit a calibration signal; receive a reflected calibration signal from a first location, the reflected calibration signal including multipath components; and transmit a localization signal; and programmable circuitry coupled to the initiator device, the programmable circuitry configurable to: determine characteristics of the reflected calibration signal; and reduce the multipath components of a reflected localization signal from a second location received at the first location using the characteristics of the reflected calibration signal received by the initiator device, wherein the reflected localization signal is a reflection of the localization signal.

### CROSS-REFERENCE TO RELATED APPLICATION

This patent application claims the benefit of and priority to U.S. Provisional Patent Application No. 63/779,706 filed Mar. 28, 2025, which is hereby incorporated herein by reference in its entirety.

### TECHNICAL FIELD

This description relates generally to channel sounding and, more particularly, to methods, apparatus, and systems for device localization with channel sounding and passive signaling.

### BACKGROUND

Wireless communication systems exchange data through a series of transmissions that take place in a communication environment. Devices receive information through an exchange of communication signals. Some wireless devices use characteristics of the communication signals to determine information about the communication environment. In a Bluetooth communication system, devices may use communication signal characteristics, such as time-of-flight, phase, and magnitude of a signal, to determine different conditions of the communication environment in which the Bluetooth communication system is operating. Some Bluetooth communication systems use communication signal characteristics across multiple devices to localize a signal source in the communication environment.

### SUMMARY

For methods, apparatus, and systems for device localization with channel sounding and passive signaling, an example apparatus includes an initiator device configurable to: transmit a calibration signal; receive a reflected calibration signal from a first location, the reflected calibration signal including multipath components; and transmit a localization signal; and programmable circuitry coupled to the initiator device, the programmable circuitry configurable to: determine characteristics of the reflected calibration signal; and reduce the multipath components of a reflected localization signal from a second location received at the first location using the characteristics of the reflected calibration signal received by the initiator device, where the reflected localization signal is a reflection of the localization signal. Other examples are described.

For methods, apparatus, and systems for device localization with channel sounding and passive signaling, an example method includes transmitting a calibration signal from a first location; determining characteristics of the calibration signal received at a second location, the characteristics of the calibration signal received at the second location including multipath components; transmitting a reflected calibration signal from the second location, the reflected calibration signal is a reflection of the calibration signal; determining characteristics of the reflected calibration signal received at the first location, the characteristics of the reflected calibration signal received at the first location including multipath components; and reducing the multipath components of a reflected localization signal from a third location and received at the second location using the characteristics of the calibration signal received at the second location and the characteristics of the reflected calibration signal received at the first location. Other examples are described.

For methods, apparatus, and systems for device localization with channel sounding and passive signaling, an example apparatus includes an initiator device configurable to: transmit a calibration signal; and receive a reflected calibration signal; a passive device configurable to: receive the calibration signal; and transmit the reflected calibration signal; and programmable circuitry coupled to the initiator device and the passive device, the programmable circuitry configurable to: determine characteristics of the calibration signal received at the passive device, the calibration signal at the passive device having multipath components; determine characteristics of the reflected calibration signal received at the initiator device, the reflected calibration signal including the multipath components; and determine characteristics of a reflected localization signal received at the passive device using the characteristics of the calibration signal received at the passive device and the reflected calibration signal received at the initiator device. Other examples are described.

### BRIEF DESCRIPTION OF THE DRAWINGS

FIG. 1 is a block diagram of an example communication system including an initiator device, a series of passive devices, and example passive signaling circuitry to locate a reflector device.

FIG. 2 is a block diagram of example signaling between the initiator, reflector, and passive devices of FIG. 1 to locate the reflector device using the passive signaling circuitry of FIG. 1 and example three-dimensional (3D) localization circuitry.

FIG. 3 is a block diagram of an example of the passive signaling circuitry of FIGS. 1 and 2.

FIG. 4 is a flowchart representative of example machine-readable instructions or example operations that may be at least one of executed, instantiated, or performed using an example implementation of the passive signaling circuitry of FIGS. 1, 2, and 3 and the 3D localization circuitry of FIG. 2 or, more generally, the communication system of FIG. 1 to locate the reflector device of FIGS. 1 and 2.

FIG. 5 is a flowchart representative of example machine-readable instructions or example operations that may be at least one of executed, instantiated, or performed using an example implementation of the passive signaling circuitry of FIGS. 1, 2, and 3 or, more generally, the communication system of FIG. 1 to calibrate channel sounding for multi-path components.

FIG. 6 is a plot of example performance of the localization of the reflector device of FIGS. 1 and 2 using the initiator and passive devices of FIGS. 1 and 2 in a first environment.

FIG. 7 is a plot of example performance of the localization of the reflector device of FIGS. 1 and 2 using the initiator and passive devices of FIGS. 1 and 2 in a second environment.

FIGS. 8A and 8B are plots of example performance of the passive signaling circuitry of FIGS. 1, 2, and 3.

FIG. 9 is a block diagram of another example of the passive signaling circuitry of FIGS. 1, 2, and 3.

FIG. 10 is a flowchart representative of example machine-readable instructions or example operations that may be at least one of executed, instantiated, or performed using an example implementation of the passive signaling circuitry of FIGS. 1, 2, and 9 and the 3D localization circuitry of FIG. 2 or, more generally, the communication system of FIG. 1 to locate the reflector device of FIGS. 1 and 2.

FIG. 11 is a plot of example performance of the localization of the reflector device of FIGS. 1 and 2 using the initiator and passive devices of FIGS. 1 and 2 using a data model and the passive signaling circuitry of FIGS. 1, 2, and 9.

FIG. 12 is a block diagram of an example processing platform including programmable circuitry structured to execute, instantiate, or perform the example machine-readable instructions or perform the example operations of FIGS. 4, 5, and 10 to implement the passive signaling circuitry and 3D localization circuitry of FIGS. 2, 3, and 9.

FIG. 13 is a block diagram of an example implementation of the programmable circuitry of FIG. 12.

FIG. 14 is a block diagram of another example implementation of the programmable circuitry of FIG. 12.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Wireless communication systems exchange data through a series of transmissions that take place in a communication environment. Devices receive information through an exchange of communication signals. Some wireless devices use characteristics of the communication signals to determine information about the communication environment. In a Bluetooth communication system, devices may use communication signal characteristics, such as time-of-flight, phase, and magnitude of a signal, to determine different conditions of the communication environment in which the Bluetooth communication system is operating. Some Bluetooth communication systems use communication signal characteristics across multiple devices to localize a signal source in the communication environment.

In characterizing a communication environment, Bluetooth communication systems differentiate between line-of-sight (LOS) conditions and non-line-of-sight (NLOS) conditions. In LOS conditions, devices interface directly, via an unobstructed transmission path. In NLOS conditions, the devices interface indirectly, via a reflection off a surface or through an obstruction. Recently, Bluetooth specifications have begun to include channel sounding specifications. Channel sounding specifications allow Bluetooth devices to determine a distance between two devices using channel frequency response (CFR) measurements. CFR measurements provide characteristics of signals, such as time-of-flight, phase, and magnitude. Some Bluetooth specifications have even begun to support CFR measurements across an increasingly wide range of frequency channels, such as seventy-five channels spaced one megahertz apart.

In Bluetooth systems, devices estimate a channel impulse response (CIR) by frequency hopping across different communication channels. The device uses the CIR to determine a signal having the shortest delay offset. Such a signal often corresponds to the most direct signal path between the devices. In LOS conditions, Bluetooth devices may use the characteristics of the determined signal to measure the distance between any two given devices. For example, once the signal having the shortest delay offset is determined using the CIR, the phase of the signal and the frequency of the signal provides a time-of-flight (t). Examples and further details of measuring distances between devices are further illustrated and described in “COMBINED PHASE AND TIME-OF-FLIGHT MEASUREMENT” U.S. patent application Ser. No. 16/680,714 (U.S. Pat. No. 11,366,216) and “MULTI-NODE BASED DISTANCE MEASUREMENT” U.S. patent application Ser. No. 19/047,825, which is incorporated by reference in its entirety.

In LOS conditions, signaling between devices produces relatively high-quality CFR measurements responsive to a lack of obstacles or surfaces that may attenuate signals. Devices may accurately differentiate between a signal of a given signaling event and noise or reflections of other signals using the relatively high-quality CFR measurements. Once differentiated, devices implement data driven models to determine a distance between devices. In LOS conditions, data driven models, such as Inverse Fast Fourier Transform (IFFT) and Multiple Signal Classification (MUSIC) models, generalize different communication environments to produce a distance measurement. Such models are referred to as LOS models. In operation, the LOS models apply characteristics of a signal to a series of parameters that generalize the communication environment. LOS models increase the accuracy of distance measurements by generalizing communication environments for signals having high-quality CFR measurements.

However, unlike the relatively high-quality CFR measurements in LOS conditions, NLOS conditions produce relatively low-quality CFR measurements. Such a reduction in the quality of CFR measurements results from challenging multi-path components. For example, an indoor environment with a first device in a users' pocket and a second device behind a wall. In such examples, signals from the first device may form a series of different paths simultaneously. A first signal path may be formed through the user and by reflecting off of surface(s) of the indoor environment. Another signal path may be formed through the user and by propagating through the wall. At any given time, the second device may simultaneously receive signals from several non-direct signal paths or even different sources. Such a combination of signals of different paths are referred to as multi-path contributions. In these NLOS conditions, Bluetooth devices can easily confuse the most direct signal path with other signal paths because of the multi-path signal contributions. Such confusion between signals of different signal paths reduces the accuracy of measurements between devices. In some examples, devices can even confuse environmental noise with multi-path signal contributions.

In NLOS or noisy multi-path conditions, the accuracy of LOS models decreases with the quality of CFR measurements. For example, in LOS conditions the LOS models have an accuracy in the centimeter range or decimeter range. However, in NLOS conditions the same LOS models have an accuracy in the multiple meter range. Although the LOS models have good performance in LOS conditions, other data models have good performance in NLOS conditions, such as support vector regression (SVR) models, neural network (NN) models, convolutional neural network (CNN) models, etc. Such data models are referred to as NLOS models. NLOS models generalize communication environments for NLOS conditions. For example, an NLOS model with good generalization can characterize a received signal from a wide range of multi-path components.

Unfortunately, some NLOS models, such as SVR and CNN models, require a substantial number of parameters to accurately generalize communication environments. For example, a CNN model, which is considered a deep learning model, generalizes communication environments using over ten-thousand different parameters. Such a large number of parameters in a low-power wireless device can consume substantial power, processing resources, and chip area and may suffer from significant latency. Also, SVR models need continually growing reference data sets for scalability. Such substantial needs for compute resources have limited the implementation of NLOS data models. For example, Bluetooth low energy (BLE) devices are unable to implement an extensive number of parameters responsive to relatively limited access to compute resources or data storage.

As Bluetooth specifications continue to support a wide range of channel sounding operations, Bluetooth communication systems have begun to include additional passive devices for localization of a reflector device. Such operations to locate the reflector device are referred to as localization operations. In localization operations, an initiator device transmits a localization signal to the passive devices and a reflector device. The reflector and passive devices determine characteristics of the received localization signal. The reflector device transmits a reflected localization signal having characteristics matching the measurements of the received localization signal. The initiator and passive devices determines characteristics of the received reflected localization signal. The initiator device uses the properties of two-way signaling to determine a channel frequency response of the signal path between the initiator and reflector devices. The initiator device can determine the distance of the signal path using the phase offset of the channel frequency response. Also, the Bluetooth communication system attempts to determine the distance between the passive devices and the reflector devices using the received reflection of the localization signal. However, unlike between the initiator and reflector devices, the passive devices do not transmit the localization signal for two-way signaling. Without two-way signaling between the passive and reflector devices to represent the channel frequency response, the Bluetooth communication system makes assumptions of the communication environment to determine the channel frequency response and corresponding distance between the reflector and passive devices.

In some Bluetooth communication systems, the passive devices are positioned at fixed locations with a line-of-sight path to the initiator device. In such systems, the phase shift of the channel frequency response for the signal path between the initiator and passive devices can be determined by dividing the distance between the devices by the speed of light. The empirically calculated channel frequency response between the initiator and passive devices can be combined using trilateration with the measurements received during localization operations to determine the channel frequency response between the reflector and passive devices. However, the empirically determined channel frequency response between the initiator and passive devices fails to account for multi-path components of the communication environment. In such Bluetooth communication systems, the multi-path components excluded from the empirical channel frequency response increases the error in localizing the reflector device.

Examples described herein include methods and apparatus for device localization with channel sounding and passive signaling using calibration operations to account for multi-path components. In some described examples, the communication system includes an initiator device, passive devices, a reflector device, and passive signaling circuitry. The initiator device transmits the localization signal and receives the reflected localization signal. The reflector device receives the localization signal and transmits the reflected localization signal. During localization operations, the passive devices receive both the localization signal and the reflected localization signal. The devices provide characteristics, such as magnitude, phase offset, etc., of the received signals to the passive signaling circuitry.

The passive signaling circuitry initiates calibration operations by causing the initiator device transmit a calibration signal. The passive devices receive the calibration signal and provide characteristics of the received calibration signal to the passive signaling circuitry. In some examples, the passive devices transmit a reflected calibration signal responsive to receiving the calibration signal. The initiator device receives the reflected calibration signal and provides characteristics of the reflected calibration signal to the passive signaling circuitry.

The passive signaling circuitry uses the additional measurements obtained during the calibration operations to characterize the channel frequency response for the signal paths between the initiator and passive devices. Advantageously, such a representation of the channel frequency response includes the multi-path components of the communication environment. The passive signaling circuitry uses calibration and localization measurements with trilateration to determine the channel frequency response of the signal paths between the reflector and passive devices. Advantageously, using the calibration measurements to determine the channel frequency response between the reflector and passive devices reduces the error from multi-path components of the distance measurements and therefore mitigates/removes the effects of multi-path signals. Advantageously, the calibration operations between the initiator and passive devices improve the accuracy of the localization of the reflector device.

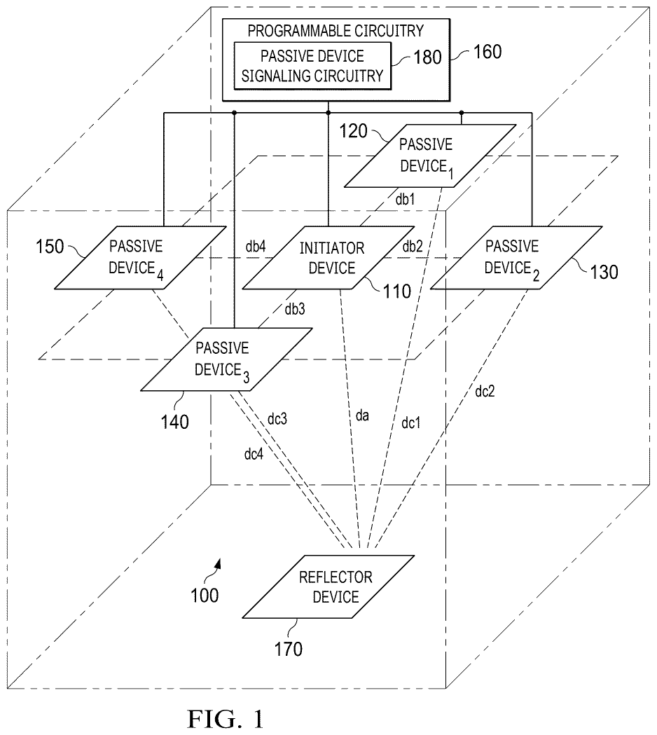

FIG. 1 is a block diagram of an example communication system 100. In the example of FIG. 1, the communication system 100 includes an initiator device 110, a first passive device 120, a second passive device 130, a third passive device 140, a fourth passive device 150, programmable circuitry 160, and a reflector device 170. The communication system 100 is a Bluetooth, Wi-Fi, or other communication system. In some examples, the communication system 100 is referred to as a BLE communication system or a Wi-Fi communication system. In some examples, the communication system 100 utilizes distance measurements (also referred to as ranging) as a means of proximity detection. In such examples, the communication system 100 uses distance measurements between different ones of the devices 110, 120, 130, 140, 150, 170 to locate the reflector device 170 in the communication environment. Such a use of distance measurements to determine a location is referred to as localization.

In some examples, the industrial or automotive industries implement the communication system for localization of the reflector device 170. In the example of FIG. 1, the communication system 100 is illustrated in the context of an indoor or contained communication environment, such as indoors. For example, if the devices 110, 120, 130, 140, 150 form an access point and the reflector device 170 is a mobile device, the communication system 100 can use localization to determine the location of the reflector device 170 in a building. In some such examples, such as in industrial uses, the location provided by distance measurements and localization may be used for validating security credentials, badge validation, smart warehouses, tracking of packages and medical equipment, geo-fencing, etc. For example, the devices 110, 120, 130, 140, 150 may be mounted on the ceiling of a warehouse or may be distributed throughout a vehicle. In another example, if the devices 110, 120, 130, 140, 150 form an entry system and the reflector device 170 is a key fob (e.g., a dedicated fob, a smartphone, a wearable device, etc.), the communication system 100 allows the entry system to determine a location of the key fob in the communication environment. In other such examples, such as in automotive uses, ranging of the communication system 100 may be used for keyless entry, passenger identification, navigation, etc. Advantageously, the communication system 100 may utilize localization across a wide range of Bluetooth enabled devices.

The initiator device 110 is communicatively coupled to the devices 120, 130, 140, 150, 170. The initiator device 110 is coupled to the programmable circuitry 160. The initiator device 110 initiates calibration operations by transmitting calibration signal(s) to the passive devices 120, 130, 140, 150. The initiator device 110 may be configurable to initiate calibration operations in response to detecting interference or a change in network/environmental conditions. Additionally or alternatively, the initiator device 110 may be configurable to initiate calibration operations at regular intervals or a particular time duration after previous calibration operations. In some examples, the initiator device 110 receives reflected calibration signal(s) from the passive devices 120, 130, 140, 150 responsive to the transmission of the calibration signal(s). The reflected calibration signal(s) include contributions from multi-path components. The multi-path components of the reflected calibration signal(s) are based on characteristics of the communication environment during calibration operations. For example, if the communication system 100 is in an indoor communication environment, reflections of the calibration signal and other signals are received by the initiator device 110 in addition to the reflected calibration signal. In such examples, the initiator device 110 cannot differentiate multi-path components from the reflected calibration signal. The initiator device 110 provides the characteristics of the reflected calibration signal (PCT_{KI,0}), which includes the multi-path components, to the programmable circuitry 160.

The initiator device 110 initiates localization operations of the reflector device 170 by transmitting a localization signal to the devices 120, 130, 140, 150, 170. The initiator device 110 receives a reflected localization signal from the reflector device 170 responsive to the transmission of the localization signal. The reflected localization signal includes contributions from multi-path components. The multi-path components of the reflected localization signal are based on the communication environment during the localization operations. The initiator device 110 provides the characteristics of the reflected localization signal (PCT_{I}), which include the multi-path components, to the programmable circuitry 160. In some examples, the multi-path components of the calibration signal and the localization are different responsive to changes in the communication environment between the calibration operations and the localization operations. Also, the locations of the initiator device 110 in relation to the passive devices 120, 130, 140, 150 or the reflector device 170 result in different multi-path components.

The passive devices 120, 130, 140, 150 are communicatively coupled to the devices 110, 170. The passive devices 120, 130, 140, 150 are coupled to the programmable circuitry 160. In the example of FIG. 1, the passive devices 120, 130, 140, 150 are located in proximity to the initiator device 110. For example, if the initiator device 110 is at a first location, the passive device 120 is located at a second location, the passive device 130 is located at a third location, the passive device 140 is located at a fourth location, and the passive device 150 is located at a fifth location. In such examples, the second location is a first distance (db1) to the north of the first location, the third location is a second distance (db2) to the east of the first location, the fourth location is a third distance (db3) to the south of the first location, and the fifth location is a fourth distance (db4) to the west of the first location. In some examples, the passive devices 120, 130, 140, 150 are positioned to have a direct line of sight (LOS) path with the initiator device 110. In other examples, the passive devices 120, 130, 140, 150 may be positioned with a non-direct line of sight (NLOS) path with the initiator device 110. Also, the communication system 100 may include a different number of passive devices (e.g., fewer than four or more than four) or orientation of the passive devices 120, 130, 140, 150 in reference to the initiator device 110.

During calibration operations, the passive devices 120, 130, 140, 150 receive the calibration signal from the initiator device 110. The calibration signal(s) received by the passive devices 120, 130, 140, 150 include multi-path components unique to locations of the passive devices 120, 130, 140, 150 and the communication environment during the calibration operations. In some example operations, the passive devices 120, 130, 140, 150 reflect the calibration signal by transmitting a reflected calibration signal responsive to receiving the calibration signal. The reflected calibration signal is a replica of the calibration signal(s) received by the passive devices 120, 130, 140, 150, which includes multi-path components. The passive devices 120, 130, 140, 150 provide characteristics of the received calibration signal (PCT_{IK,0}), which includes the multi-path components, to the programmable circuitry 160. Advantageously, the programmable circuitry 160 can characterize the channel frequency responses with multi-path components between the initiator device 110 and the passive devices 120, 130, 140, 150 using the two-way signaling during the calibration operations.

During localization operations, the passive devices 120, 130, 140, 150 receive the localization signal from the initiator device 110. The localization signal received by the passive devices 120, 130, 140, 150 includes the multi-path components unique to locations of the passive devices 120, 130, 140, 150 and the communication environment during the localization operations. The passive devices 120, 130, 140, 150 also receive a reflected localization signal from the reflector device 170. The reflected localization signal received by the passive devices 120, 130, 140, 150 includes multi-path components unique to the locations of the passive devices 120, 130, 140, 150 in relation to the reflector device 170 and the communication environment during the localization operations. Unlike the multi-path components of the localization signal received by the passive devices 120, 130, 140, 150, the multi-path components of the reflected localization signal received by the passive devices 120, 130, 140, 150 includes contributions from traversing from the reflector device 170. For example, a first distance (dc1) separates the devices 120, 170, a second distance (dc2) separates the devices 130, 170, a third distance (dc3) separates the devices 140, 170, and a fourth distance (dc3) separates the devices 150, 170. In such examples, the multi-path contributions at each of the passive devices 120, 130, 140, 150 can differ. The passive devices 120, 130, 140, 150 provide characteristics of the received localization and reflected localization signals (PCT_{IK}, PCT_{RK}), which include the multi-path components, to the programmable circuitry 160.

The programmable circuitry 160 is coupled to the devices 110, 120, 130, 140, 150. The example programmable circuitry 160 of FIG. 1 includes passive signaling circuitry 180. The passive signaling circuitry 180 sequences transmission and reception of signals by the devices 110, 120, 130, 140, 150 for the calibration and localization operations. The programmable circuitry 160 receives characteristics of the calibration and localization signals (PCT_{IK,0}, PCT_{KI,0}, PCT_{IK}, PCT_{RK}) received and reflected by the devices 110, 120, 130, 140, 150. The passive signaling circuitry 180 uses the characteristics of the received calibration and reflected calibration signal (PCT_{IK,0}, PCT_{KI,0}) to reduce the multi-path components of the characteristics of the received localization signal (PCT_{IK}) in determining the channel frequency response (Ĥ_{CK}) of the reflected localization signal received by the passive devices 120, 130, 140, 150 during localization operations.

Advantageously, reducing the multi-path components of the reflected localization signal received by the passive devices 120, 130, 140, 150 increases the accuracy of the determined channel frequency response (Ĥ_{CK}). Advantageously, increasing the accuracy of the channel frequency response (Ĥ_{CK}) between the passive devices 120, 130, 140, 150 and the reflector device 170 increases the accuracy of the accuracy of distance measurements between the passive devices 120, 130, 140, 150 and the reflector device 170. Advantageously, increasing the accuracy of the distance measurements increases the accuracy of localization operations.

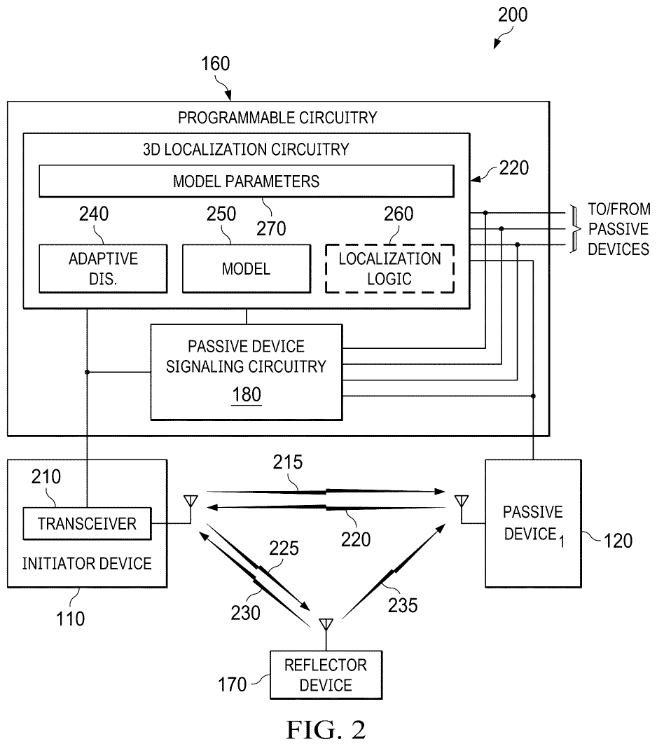

The reflector device 170 is communicatively coupled to the devices 110, 120, 130, 140, 150. During localization operations, the reflector device 170 receives the localization signal from the initiator device 110. The localization signal received by the reflector device 170 includes multi-path components unique to the communication environment during the localization operations. The reflector device 170 reflects the received localization signal by transmitting a reflected localization signal responsive to receiving the localization signal. The reflected localization signal is a replica of the received localization signal, which includes multi-path components. Advantageously, measuring characteristics of the reflected localization signal using the devices 110, 120, 130, 140, 150 allows the programmable circuitry 160 to determine a location of the reflector device 170 in the communication environment. Example operations of the localization of the reflector device 170 are further illustrated and described in connection with FIG. 2.

FIG. 2 is a block diagram of an example communication system 200, which is a portion of the communication system 100 of FIG. 1. In the example of FIG. 2, the communication system 200 includes the initiator device 110, the passive device 120, the programmable circuitry 160, and the reflector device 170. The communication system 200 locates the reflector device 170 using distance measurements between the initiator device 110, the passive devices 120, 130, 140, 150, and the reflector device 170. Although in the example of FIG. 2 only the passive device 120 is illustrated, the communication system 200 includes any plurality of passive devices, such as the passive devices 130, 140, 150, to locate the reflector device 170 in the communication environment.

The initiator device 110 is communicatively coupled to the devices 120, 170. The initiator device 110 is coupled to the programmable circuitry 160. The example initiator device 110 of FIG. 2 includes a transceiver 205. The transceiver 205 transmits a calibration signal 215 and a localization signal 225. The transceiver 205 receives a reflected calibration signal 220 and a reflected localization signal 230 responsive to the transmission of at least one of the calibration signal 215 or the localization signal 225. The transceiver 205 measures characteristics of the reflected calibration signal 220 and the reflected localization signal 230 received at the initiator device 110. The transceiver 205 provides the characteristics of the reflected calibration signal 220 (PCT_{KI,0}) and the reflected localization signal 230 (PCT_{I}) received at the initiator device 110 to the programmable circuitry 160. As mentioned above, the transceiver 205 measures the characteristics of the reflected calibration signal 220 (PCT_{KI,0}) and the reflected localization signal 230 (PCT_{I}) with the multi-path components.

The passive device 120 is communicatively coupled to the devices 110, 170. Similar to the initiator device 110, the passive device 120 includes an instance of the transceiver 205. However, unlike the initiator device 110, the passive device 120 provides measured characteristics of the calibration signal 220 (PCT_{IK,0}), the localization signal 215 (PCT_{IK}), and a reflected localization signal 230 (PCT_{RK}) received by the passive device 120 to the programmable circuitry 160.

The programmable circuitry 160 is coupled to the devices 110, 120. In some examples, the programmable circuitry 160 may be coupled to any number of passive devices, such as the passive devices 130, 140, 150. The example programmable circuitry 160 of FIG. 2 includes the passive signaling circuitry 180 and 3D localization circuitry 210. The passive signaling circuitry 180 sequences the calibration and localization operations using the initiator device 110. The passive signaling circuitry 180 receives the characteristics of the received and reflected calibration signals (PCT_{IK,0}, PCT_{KI,0}) and the received and reflected localization signals (PCT_{IK}, PCT_{I}, PCT_{RK}) from the devices 110, 120. The passive signaling circuitry 180 determines the channel frequency response (Ĥ_{CK}) of the reflected localization signal received by the passive device 120 using characteristics of the received and reflected calibration signals (PCT_{IK,0}, PCT_{KI,0}) and the received and reflected localization signals (PCT_{IK}, PCT_{I}, PCT_{RK}) from the devices 110, 120.

In example operations, the measurements of the characteristics of the signals (PCT_{IK,0}, PCT_{KI,0}, PCT_{IK}, PCT_{I}, PCT_{RK}) include a local oscillator phase offset (e^{j(θ)}) from the interface between different devices during signaling. Without the local oscillator phase offset, the remaining portion of the measurements are an amplitude (α), phase offset (θ), and a time-of-flight (τ) that are impacted by the signal path between devices. In some examples, the amplitude (α), the phase (θ), and the time-of-flight (τ) are represented using the channel frequency response (H). The multi-path components affect the amplitude and phase of the signal, while the time-of-flight is representative of the distance between devices. Advantageously, similar signals traversing the same path can be represented using the channel frequency response of the corresponding path.

In the example of FIG. 2, a first channel frequency response (H_{bk}) represents signals traversing a first path between the devices 110, 120 during localization operations. A second channel frequency response (H_{bk,0}) represents signals traversing the first path between the devices 110, 120 during calibration operations. A third channel frequency response (Hₐ) represents signals traversing a second path between the devices 110, 170. A third channel frequency response (H_{CK}) represents signals traversing a third path between the devices 120, 170. In such examples, the initiator device 110 has a first local phase offset (e^{j(θ}^{ₗ}⁾), the passive device 120 has a second local phase offset (e^{j(θ}^{ₖ}⁾), and the reflector device 170 has a third local phase offset (e^{j(θ}^{_{R}}⁾).

In the example of FIG. 2, the measurements of the characteristics of the calibration signal 215 (PCT_{lk,0}) by the passive device 120 can be represented using Equation (1). Similarly, the measurements of the characteristics of a localization signal (PCTₗₖ) by the passive device 120 can be represented using Equation (2). The measurements of the characteristics of the reflected calibration signal 220 (PCT_{kl,0}) by the initiator device 110 can be represented using Equation (3). The measurements of the characteristics of the localization signal 225 (PCT_{R}) by the reflector device 170 can be represented using Equation (4). The measurements of the characteristics of the reflected localization signal 230 (PCTₗ) by the initiator device 110 can be represented using Equation (5). The measurements of the characteristics of the reflected localization signal 235 (PCT_{RK}) by the passive device 120 can be represented using Equation (6).

$${PCT}_{Ik , 0} = {e}^{j ( {θ}_{I} - {θ}_{k} )} {H}_{bk , 0} \qquad Equation ( 1 )$$

$${PCT}_{Ik} = {e}^{j ( {θ}_{I} - {θ}_{k} )} {H}_{bk} \qquad Equation ( 2 )$$

$${PCT}_{kI , 0} = {e}^{j ( {θ}_{k} - {θ}_{I} )} {H}_{bk , 0} \qquad Equation ( 3 )$$

$${PCT}_{R} = {e}^{j ( {θ}_{1} - {θ}_{R} )} {H}_{a} \qquad Equation ( 4 )$$

$${PCT}_{I} = {e}^{j ( {θ}_{R} - {θ}_{I} )} {H}_{a} \qquad Equation ( 5 )$$

$${PCT}_{Rk} = {e}^{j ( {θ}_{R} - {θ}_{k} )} {H}_{ck} \qquad Equation ( 6 )$$

In example operations, determining the distance between the passive device 120 and the reflector device 170 begins with determining the channel frequency response (H_{ck}). In some examples, the passive signaling circuitry 180 uses trilateration to calculate the channel frequency response (H_{ck}) between the devices 120, 170 using measurements of the signals 215, 220, 225, 230 at different locations. For example, Equation (7) is a trilateration equation where the channel frequency response (H_{ck}) is the unknown using the measurements represented by Equations (1)-(6). Advantageously, as illustrated in Equations (8) and (9), using the measurements of the signals 215, 220, 225, 230 to represent the channel frequency response (H_{ck}) cancels out the local phase offsets between the devices 110, 120, 170. Similarly, as illustrated by Equation (10), using Equation (7) and the measurements of the signals 215, 220, 225, 230, 235 results in an error approximately equal to the difference in the channel frequency response (H_{bk}) during localization operations and the channel frequency response (H_{bk,0}) during calibration between the devices 110, 120.

$${\hat{H}}_{ck}^{2} = {( \frac{{PCT}_{Rk}}{{PCT}_{Ik}} )}^{2} ( \frac{{PCT}_{R}}{{PCT}_{I}} ) ( {PCT}_{Ik , 0} {PCT}_{kI , 0} ) \qquad Equation ( 7 )$$

$${\hat{H}}_{ck}^{2} = {( \frac{{e}^{j ( {θ}_{R} - {θ}_{k} )} {H}_{ck}}{{e}^{j ( {θ}_{I} - {θ}_{k} )} {H}_{bk}} )}^{2} ( \frac{{e}^{j ( {θ}_{I} - {θ}_{R} )} {H}_{a}}{{e}^{j ( {θ}_{R} - {θ}_{I} )} {H}_{a}} ) ( {e}^{j ( {θ}_{I} - {θ}_{k} )} {H}_{bk , 0} ) ( {e}^{j ( {θ}_{k} - {θ}_{I} )} {H}_{bk , 0} ) \qquad Equation ( 8 )$$

$${\hat{H}}_{ck}^{2} = {( \frac{{e}^{j ( {θ}_{R} - {θ}_{I} )} {H}_{ck}}{{H}_{bk}} )}^{2} ( {e}^{2 j ( {θ}_{I} - {θ}_{R} )} ) {H}_{bk , 0}^{2} \qquad Equation ( 9 )$$

$${\hat{H}}_{ck}^{2} = \frac{{H}_{ck}^{2}}{{H}_{bk}^{2}} {H}_{bk , 0}^{2} \qquad Equation ( 10 )$$

Advantageously, using Equation (7) and the measurements of the signals 215, 220, 225, 230, 235 to determine the channel frequency response (H_{ck}) reduces the multi-path components by canceling common multi-path components. Advantageously, canceling out the multi-path components of the communication environment using trilateration and the measurements of the signals 215, 220, 225, 230 by the devices 110, 120, 170 increases the accuracy of the localization of the reflector device 170. Advantageously, reducing the time between the calibration and localization operations reduces the mismatch in canceling the channel frequency response (H_{bk}) in Equation (10).

The 3D localization circuitry 210 is coupled to the devices 110, 120 and the passive signaling circuitry 180. The example 3D localization circuitry 210 of FIG. 2 includes adaptive distance measurement circuitry 240, modeling circuitry 250, localization logic 260, and model parameters 270. The 3D localization circuitry 210 may receive the measurements of the signals 215, 220, 225, 230, 235, which are illustrated by Equations (1)-(6), from the devices 110, 120, 170. The 3D localization circuitry 210 receives the channel frequency response (H_{ck}) of the path between the devices 120, 170 from the passive signaling circuitry 180. In some examples, such as in FIG. 1, the 3D localization circuitry 210 may receive a channel frequency response (H_{ck}) for each of the passive devices 120, 130, 140, 150.

In some example implementations of the 3D localization circuitry 210, the adaptive distance measurement circuitry 240 determines a quality metric (Q3) across a series of localization operations, which provide a channel frequency response (H_{ck}) measurement. The quality metric represents the change in amplitudes across a series of channel frequency response (H_{ck}) measurements. The adaptive distance measurement circuitry 240 compares the quality metric (Q3) to a threshold. If the quality metric (Q3) is less than the threshold, the adaptive distance measurement circuitry 240 determines the corresponding channel frequency response (H_{ck}) measurements correspond to a line-of-sight path. For example, the path between the devices 120, 170 is a line-of-sight path when unobstructed. Alternatively, if the quality metric (Q3) is greater than the threshold, the adaptive distance measurement circuitry 240 determines the corresponding channel frequency response (H_{ck}) measurements correspond to a non-line-of-sight path. For example, the path between the devices 120, 170 is a non-line-of-sight path when obstructed or corresponds to an indirect signal path. Examples of determining the channel frequency response (Hₐ) using two-way signaling, the adaptive distance measurement circuitry, and the quality metric (Q3) are further illustrated and described in “METHODS AND APPARATUS TO ADAPTIVELY MEASURE DISTANCES” U.S. patent application Ser. No. 19/060,169, which is incorporated by reference in its entirety.

In some examples of the 3D localization circuitry 210, the modeling circuitry 250 uses the model parameters 270 to implement a trained model (e.g., an artificial intelligence (AI) model). In examples using the adaptive distance measurement circuitry 240, the modeling circuitry 250 selects a trained model to implement responsive to the comparison of the quality metric (Q3). In such examples, the model parameters include parameters to implement a plurality of different trained models. For example, if the quality metric (Q3) is less than the threshold, the modeling circuitry 250 implements a LOS model using a first portion of the model parameters 270, which represent a trained model for line-of-sight conditions. Alternatively, if the quality metric (Q3) is greater than the threshold, the modeling circuitry 250 implements a NLOS model using a second portion of the model parameters 270, which represent a trained model for non-line-of-sight conditions.

In some example operations, the trained model of the modeling circuitry 250 uses the channel frequency responses (Hₐ, H_{ck}, H_{bk}) to determine distances between the devices 110, 120, 170. In such examples, the localization logic 260 determines a location of the reflector device 170 using the distances from the modeling circuitry 250. For example, the localization logic 260 uses trilateration and geometry to determine a location of the reflector device 170 based on the distances from the modeling circuitry 250.

In other example operations, the trained model of the modeling circuitry 250 uses the channel frequency responses (Hₐ, H_{ck}, H_{bk}) to determine a location of the reflector device 170. In such examples, the modeling circuitry 250 implements a trained model that produces a location of the reflector device 170 responsive to the channel frequency responses (Hₐ, H_{ck}, H_{bk}). However, the accuracy of the trained model of the modeling circuitry 250 may be limited by the resolution of the channel frequency responses (Hₐ, H_{ck}, H_{bk}). For example, when using Equation (7) to determine the channel frequency response (H_{ck}) between the devices 120, 170, the amplitudes of the reflected localization signal 235 (PCT_{RK}) and the localization signal 215 (PCTₗₖ) cancel. Advantageously, as illustrated in Equation (11), using the conjugate of the localization signal 215 (conj (PCTₗₖ)) maintains the amplitudes of the reflected localization signal 235 (PCT_{RK}) and the localization signal 215 (PCTₗₖ) in the channel frequency response (H_{ck}).

$${\hat{H}}_{ck}^{2} = {( {PCT}_{Rk} \cdot conj ( {PCT}_{ik} ) )}^{2} ( \frac{{PCT}_{R}}{{PCT}_{I}} ) ( {PCT}_{Ik , 0} {PCT}_{kI , 0} ) \qquad Equation ( 11 )$$

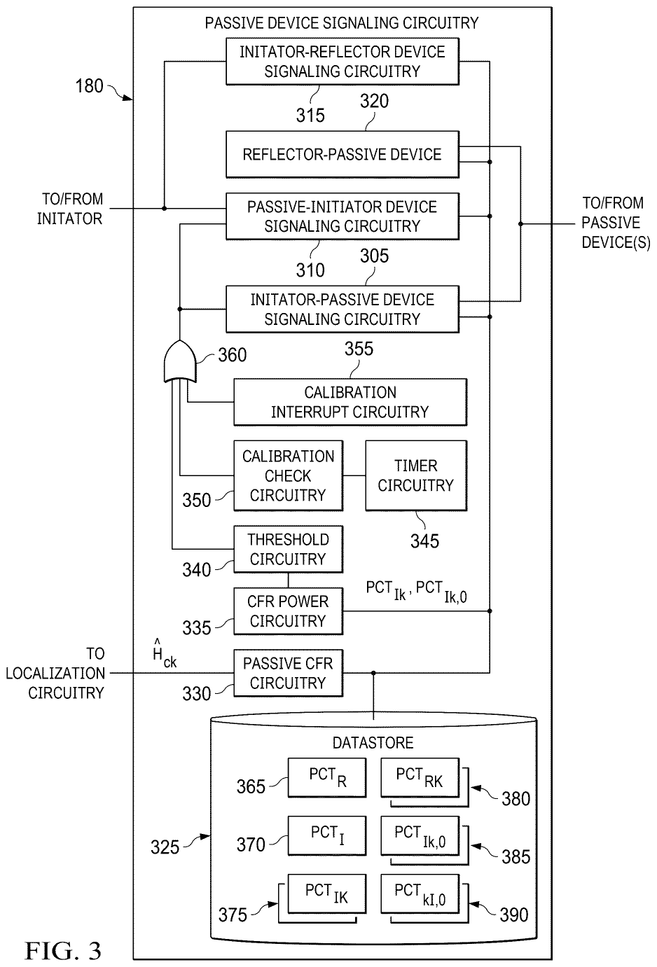

Advantageously, using Equation (11) to determine the channel frequency response (H_{ck}) between the devices 120, 170 maintains the magnitudes of the signals 215, 235. Advantageously, when the modeling circuitry 250 implements a trained model to produce a location of the reflector device 170, maintaining the magnitudes of the channel frequency response (H_{ck}) increases the accuracy. Example operations of the passive signaling circuitry 180 and the 3D localization circuitry 210 or, more generally, the communication system 200 for locating the reflector device 170 are further illustrated and described in connection with FIGS. 3, 4, 5, 9, and 10.

FIG. 3 is a block diagram of an example implementation of the passive signaling circuitry 180 of FIGS. 1 and 2 to determine characteristics of signals reflected by the reflector device 170 and received by the passive devices 120, 130, 140, 150. The passive signaling circuitry 180 of FIG. 3 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the passive signaling circuitry 180 of FIG. 3 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 3 may, thus, be instantiated at the same or different times. Some or all of the circuitry of FIG. 3 may be instantiated, for example, in one or more threads executing concurrently on hardware or in series on hardware. Moreover, in some examples, some or all of the circuitry of FIG. 3 may be implemented by microprocessor circuitry executing instructions or FPGA circuitry performing operations to implement one or more virtual machines or containers.

The passive signaling circuitry 180 is structured to be coupled to the devices 110, 120, 130, 140, 150. The example passive signaling circuitry 180 of FIG. 3 includes initiator-passive signaling circuitry 305, passive-initiator signaling circuitry 310, initiator-reflector signaling circuitry 315, reflector-passive signaling circuitry 320, a datastore 325, passive CFR circuitry 330, CFR power circuitry 335, threshold circuitry 340, timer circuitry 345, calibration check circuitry 350, calibration interrupt circuitry 355, and a logic device 360. The passive signaling circuitry 180 uses calibration and localization operations of the communication systems 100, 200 to determine the channel frequency response (H_{ck}) between the initiator device 110 and any of the passive devices 120, 130, 140, 150. In some examples, the passive signaling circuitry 180 determines a channel frequency response (H_{ck}) for each of the passive devices 120, 130, 140, 150. In such examples, the 3D localization circuitry 210 determines the distance between each of the passive devices 120, 130, 140, 150 and the reflector device 170 using the plurality of channel frequency responses (H_{ck}).

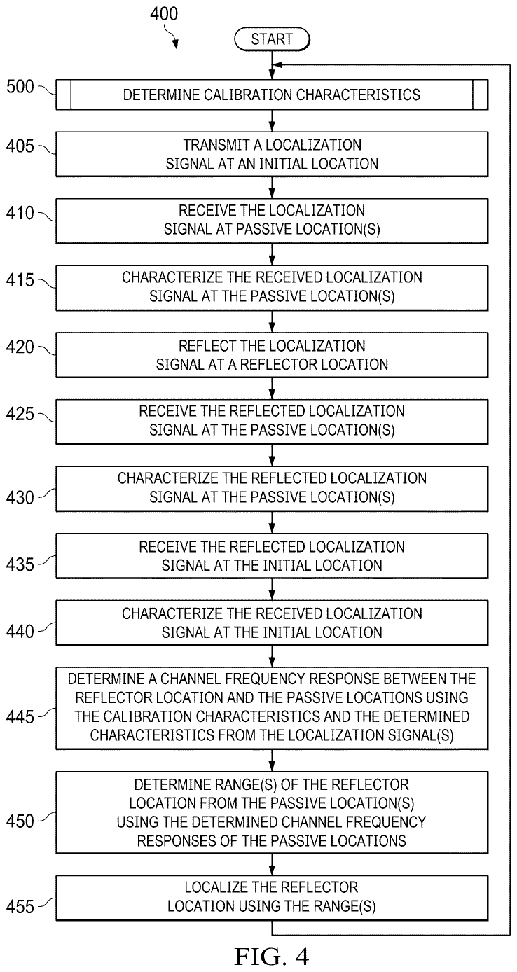

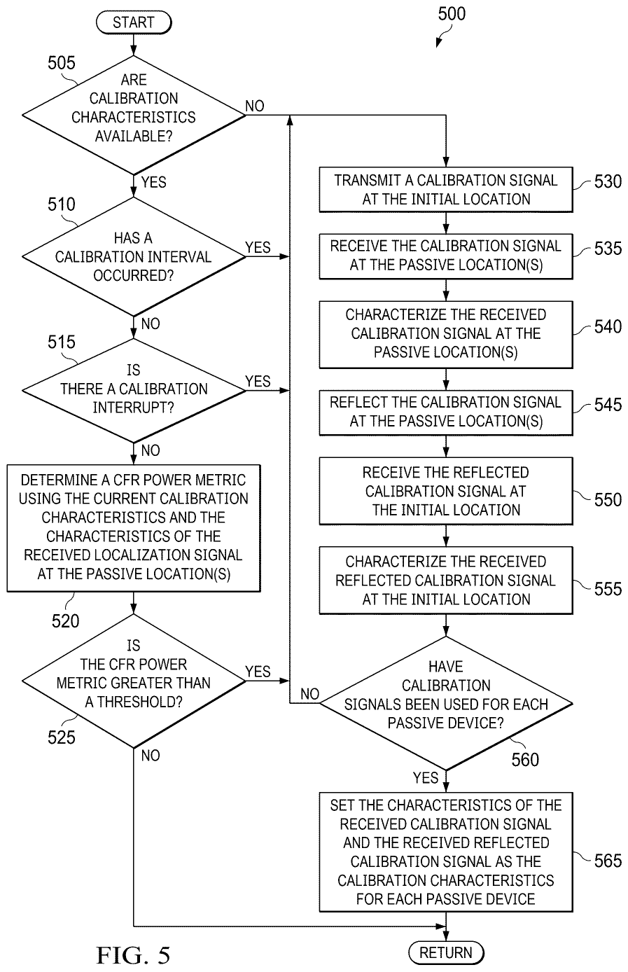

The initiator-passive signaling circuitry 305 receives the characteristics of the calibration and localization signals received by the passive devices 120, 130, 140, 150. The initiator-passive signaling circuitry 305 stores the characteristics of the calibration signal received by the passive devices 120, 130, 140, 150 as measurements 375 (PCT_{IK}) in the datastore 325. The initiator-passive signaling circuitry 305 stores the characteristics of the localization signals received by the passive devices 120, 130, 140, 150 as measurements 375 (PCT_{IK}) in the datastore 325. The initiator-passive signaling circuitry 305 stores the characteristics of the calibration signals received by the passive devices 120, 130, 140, 150 as measurements 385 (PCT_{IK,0}) in the datastore 325. In some examples, the initiator-passive signaling circuitry 305 is instantiated by ASIC or programmable circuitry executing initiator-passive signaling instructions to perform operations such as those represented by the flowcharts of FIGS. 4 and 5.

The passive-initiator signaling circuitry 310 receives the characteristics of the reflected calibration signals received by the initiator device 110. The passive-initiator signaling circuitry 310 stores the characteristics of the reflected calibration signal received by the initiator device 110 as measurements 390 (PCT_{KI,0}) in the datastore 325. In some examples, the passive-initiator signaling circuitry 310 is instantiated by ASIC or programmable circuitry executing passive-initiator signaling instructions to perform operations such as those represented by the flowcharts of FIGS. 4 and 5.

The initiator-reflector signaling circuitry 315 receives the characteristics of the localization signal received by the reflector device 170 and the reflected localization signal received by the initiator device 110. The initiator-reflector signaling circuitry 315 stores the characteristics of the localization signal received by the reflector device 170 as measurement 365 (PCT_{R}) in the datastore 325. The initiator-reflector signaling circuitry 315 stores the characteristics of the reflected localization signal received by the initiator device 110 as measurement 370 (PCT_{I}) in the datastore 325. In some examples, the initiator-reflector signaling circuitry 315 is instantiated by ASIC or programmable circuitry executing initiator-reflector signaling instructions to perform operations such as those represented by the flowcharts of FIGS. 4 and 5.

The reflector-passive signaling circuitry 320 receives the characteristics of the reflected localization signals received by the passive devices 120, 130, 140, 150. The reflector-passive signaling circuitry 320 stores the characteristics of the reflected localization signals received by the passive devices 120, 130, 140, 150 as measurements 380 (PCT_{RK}). In some examples, the reflector-passive signaling circuitry 320 is instantiated by ASIC or programmable circuitry executing passive-reflector signaling instructions to perform operations such as those represented by the flowcharts of FIGS. 4 and 5.

The datastore 325 is a memory or a portion of memory. The datastore 325 stores the measurements 365, 370, 375, 380, 385, 390. In some examples, the datastore 325 is illustrated and described external to the passive signaling circuitry 180. In such examples, the datastore 325 may be further illustrated or described externally to the programmable circuitry 160.

The passive CFR circuitry 330 receives the measurements 365, 370, 375, 380, 385, 390 from the datastore 325. The passive CFR circuitry 330 determines the channel frequency response (H_{ck}) for the passive devices 120, 130, 140, 150 using Equation (7), above, and the corresponding ones of the measurements 365, 370, 375, 380, 385, 390. The passive CFR circuitry 330 provides the channel frequency response (H_{ck}) for each of the passive devices 120, 130, 140, 150 to the 3D localization circuitry 210. In some examples, the passive CFR circuitry 330 is instantiated by ASIC or programmable circuitry executing passive CFR instructions to perform operations such as those represented by the flowcharts of FIGS. 4 and 5.

The CFR power circuitry 335 receives the measurements 375, 385 from the datastore 325. The CFR power circuitry 335 determines a metric (Q) using the measurements 375, 385 and Equation (12). The metric (Q) represents a residual CFR power ratio of the signaling between the initiator device 110 and the passive devices 120, 130, 140, 150. Specifically, the metric (Q) is a ratio of a difference between calibration and localization signaling between the initiator device 110 and at least one of the passive devices 120, 130, 140, 150. In example operations, the metric (Q) represents changes in a communication environment between calibration and localization operations. For example, the magnitude of the measurements 375, which represent the localization signal received by the passive devices 120, 130, 140, 150, changes as multipath components increase or decrease. In such examples, changes in the communication environment, such as additional surfaces for signals to reflect off, modify the contributions of multipath components. The CFR power circuitry 335 provides the metric (Q) to the threshold circuitry 340. In some examples, the CFR power circuitry 335 is instantiated by ASIC or programmable circuitry executing CFR power instructions to perform operations such as those represented by the flowcharts of FIGS. 4 and 5.

$$Q = \frac{1}{N} {\sum }_{n = 1}^{N} \frac{\vert {\vert {PCT}_{Ik} \vert}^{2} - {\vert {PCT}_{Ik , 0} \vert}^{2} \vert}{\frac{1}{N} {\sum }_{n = 1}^{N} {\vert {PCT}_{Ik , 0} \vert}^{2}} \qquad Equation ( 12 )$$

The threshold circuitry 340 receives the metric (Q) of Equation (12) from the CFR power circuitry 335. The threshold circuitry 340 compares the metric (Q) to a threshold. The threshold of the threshold circuitry 340 represents a tolerable change in the residual CFR power ration of signals between the initiator device 110 and the passive devices 120, 130, 140, 150. In some examples, the threshold of the threshold circuitry 340 represents the amount of change in the communication environment or, more generally, the multipath components. The threshold circuitry 340 asserts an output responsive to a determination that the metric (Q) is greater than or equal to the threshold. In some examples, the threshold circuitry 340 is instantiated by ASIC or programmable circuitry executing threshold instructions to perform operations such as those represented by the flowcharts of FIGS. 4 and 5.

The timer circuitry 345 periodically generates a calibration indication. For example, the timer circuitry 345 generates a calibration indication every ten seconds. The timer circuitry 345 provides the calibration indication to the calibration check circuitry 350. In some examples, the timer circuitry 345 is instantiated by ASIC or programmable circuitry executing timer circuitry 345 instructions to perform operations such as those represented by the flowcharts of FIGS. 4 and 5.

The calibration check circuitry 350 receives the periodic calibration indications from the timer circuitry 345. The calibration check circuitry 350 checks a state of the communication system 100 responsive to the periodic calibration indications. The calibration check circuitry 350 asserts an output responsive to a determination that the state of the communication system 100 allows for a re-calibration of the measurements 385, 390. For example, the calibration check circuitry 350 verifies that the state of network traffic of the communication system 100 is at an acceptable level. In such examples, if the calibration check circuitry 350 continues to determine the state of the communication system 100 allows for calibration operations, the calibration check circuitry 350 periodically asserts the output. In some examples, the calibration check circuitry 350 is instantiated by ASIC or programmable circuitry executing calibration check instructions to perform operations such as those represented by the flowcharts of FIGS. 4 and 5.

The calibration interrupt circuitry 355 generates an interrupt (e.g., alarms) responsive to conditions of an interrupt service routine being met. For example, the calibration interrupt circuitry 355 implements an interrupt service routing to generate an interrupt responsive to a firmware update, update to the model parameters 270, etc. In some examples, the calibration interrupt circuitry 355 is instantiated by ASIC or programmable circuitry executing calibration interrupt instructions to perform operations such as those represented by the flowcharts of FIGS. 4 and 5.

The logic device 360 receives the outputs of the threshold circuitry 340, the calibration check circuitry 350, and the calibration interrupt circuitry 355. In the example of FIG. 3, the logic device 360 is an OR gate, which asserts an output responsive to a logic one from any of the threshold circuitry 340, the calibration check circuitry 350, or the calibration interrupt circuitry 355. The initiator-passive signaling circuitry 305 and the passive-initiator signaling circuitry 310 perform calibration operations to reobtain the measurements 385, 390 responsive to the logic device 360 asserting the output. In some examples, the logic device 360 is instantiated by programmable circuitry executing logic device instructions to perform operations such as those represented by the flowcharts of FIGS. 4 and 5.

FIG. 4 is a flowchart representative of example machine-readable instructions or example operations 400 that may be at least one of executed, instantiated, or performed using an example implementation of the passive signaling circuitry 180 of FIGS. 1, 2, and 3 and the 3D localization circuitry 210 of FIG. 2 or, more generally, the communication system 100 of FIG. 1 to locate the reflector device 170 of FIGS. 1 and 2. The example operations 400 of FIG. 4 begin with example operations 500 of FIG. 5 at which, the passive signaling circuitry 180 determines calibration characteristics. In example operations, as further illustrated and described in connection with FIG. 5, the passive signaling circuitry 180 sequencing signaling between the initiator device 110 and the passive devices 120, 130, 140, 150 to receive the measurements 385, 390. In some examples, the measurements 385 represent calibration signals received by the passive devices 120, 130, 140, 150 from the initiator device 110. In such examples, the measurements 390 represent reflected calibration signals received by the initiator device 110 from the passive devices 120, 130, 140, 150. In such example operations, the measurements 385, 390 include multi-path components resulting from the communication environment. Control proceeds to Block 405.

The initiator device 110 transmits a localization signal at an initial location. (Block 405). In example operations, the initiator device 110 begins localization operations by transmitting a localization signal. In some examples, the initiator device 110 sets a magnitude, phase, and frequency of the localization signal based on a specific signaling process. For example, in some examples, the initiator device 110 adjusts the frequency of the localization signal after each localization operation. Such example frequency adjustments of the localization signal are referred to as channel hopping. In such examples, the initiator device 110 rotates between the seventy-five BLE channels by adjusting the localization signal by one megahertz after each localization operation.

The passive devices 120, 130, 140, 150 receive the localization signal at passive location(s). (Block 410). In example operations, the localization signal propagates through the communication environment to the passive devices 120, 130, 140, 150. During propagation, characteristics of the communication environment and the signal path modify characteristics of the localization signal. For example, the time of flight (τ) adds a phase shift to the localization signal. In such example operations, the passive devices 120, 130, 140, 150 receive the localization signal from the initiator device 110.

The initiator-passive signaling circuitry 305 characterizes the received localization signal at the passive location(s). (Block 415). In example operations, the path between the initiator device 110 and the passive devices 120, 130, 140, 150 is characterized by a channel frequency response (H_{bk}) or, more generally, the measurements 375 (PCT_{IK}). The measurements 375 (PCT_{IK}) represent the channel frequency response (H_{bk}) of the paths between the initiator device 110 and the passive devices 120, 130, 140, 150. For example, the channel frequency response (H_{bk}) for a path between the initiator device 110 and the passive devices 120, 130, 140, 150 can be determined using Equation (2), the measurements 375 (PCT_{IK}), and the local phase offset. In such example operations, the initiator-passive signaling circuitry 305 produces the measurements 375 (PCT_{IK}) using magnitude, frequency, and phase of the localization signal received by the passive devices 120, 130, 140, 150.

The reflector device 170 reflects the localization signal at a reflector location. (Block 420). In example operations, the reflector device 170 receives the localization signal from the initiator device 110. In some examples, the reflector device 170 may characterize the localization signal by measuring the received localization signal, such as the measurement 365 (PCT_{R}). In such example operations, the reflector device 170 transmits a reflected localization signal having characteristics matching the received localization signal. Such an operation of transmitting a signal having characteristics of a received signal is referred to as a reflection.

The passive devices 120, 130, 140, 150 receive the reflected localization signal at the passive location(s). (Block 425). In example operations, the reflected localization signal propagates through the communication environment to the passive devices 120, 130, 140, 150. In example operations, the passive devices 120, 130, 140, 150 receive the reflected localization signal from the reflector device 170.

The reflector-passive signaling circuitry 320 characterizes the reflected localization signal at the passive location(s). (Block 430). In example operations, the paths between the passive devices 120, 130, 140, 150 and the reflector device 170 are characterized by a channel frequency response (H_{ck}) or, more generally, the measurements 380 (PCT_{RK}). The measurements 380 (PCT_{RK}) represent the channel frequency response (H_{ck}) of the paths between the passive devices 120, 130, 140, 150 and the reflector device 170. In such example operations, the reflector-passive signaling circuitry 320 produces the measurements 380 (PCT_{RK}) using magnitude, frequency, and phase of the reflected localization signal received by the passive devices 120, 130, 140, 150.

The initiator device 110 receives the reflected localization signal at the initial location. (Block 435). In example operations, the reflected localization signal propagates through the communication environment to the initiator device 110. In example operations, the initiator device 110 receives the reflected localization signal from the reflector device 170.

The initiator-reflector signaling circuitry 315 characterizes the reflected localization signal at the initial location. (Block 440). In example operations, the path between the initiator device 110 and the reflector device 170 is characterized by a channel frequency response (Hₐ) or, more generally, the measurement 370 (PCT_{I}). The measurement 370 (PCT_{I}) represents the channel frequency response (Hₐ) of the path between the initiator device 110 and the reflector device 170. In such example operations, the initiator-reflector signaling circuitry 315 produces the measurement 370 (PCT_{I}) using magnitude, frequency, and phase of the reflected localization signal received by the initiator device 110. Advantageously, the measurement 370 (PCT_{I}) represents two-way signaling along the signal path between the initiator device 110 and the reflector device 170.

The passive CFR circuitry 330 determines a channel frequency response between the reflector location and the passive locations using the calibration characteristics and the determined characteristics from the localization signal(s). (Block 445). In example operations, the channel frequency response (H_{ck}) or, more generally, the measurements 380 (PCT_{RK}) represent signal paths between the passive devices 120, 130, 140, 150 and the reflector device 170. In some examples, the passive CFR circuitry 330 determines the channel frequency response (H_{ck}) using Equation (7) and the measurements 365, 370, 375, 380, 385, 390. In such examples, the measurements 385, 390 (PCT_{IK,0}, PCT_{KI,0}) represent the calibration characteristics of the communication system 100. In such example operations, the passive CFR circuitry 330 determines the channel frequency response (H_{ck}) for the paths between the passive devices 120, 130, 140, 150 and the reflector device 170. Advantageously, using Equation (7) and the measurements 365, 370, 375, 380, 385, 390 reduces the multipath components of the channel frequency response (H_{ck}).

Additionally, in some examples, the programmable circuitry 270 determines the channel frequency response (Hₐ) using the measurements 365, 370. The channel frequency response (Hₐ) represents the signal path between the initiator device 110 and the reflector device 170. Advantageously, unlike the channel frequency response (H_{ck}) for the paths between the passive devices 120, 130, 140, 150 and the reflector device 170, the channel frequency response (Hₐ) can be determined using the two-way signaling of the measurements 365, 370.

The 3D localization circuitry 210 determines range(s) of the reflector location from the passive locations using the determined channel frequency responses of the passive locations. (Block 450). In example operations, the 3D localization circuitry 210 uses the model parameters 270 to determine a range from the reflector device 170 to the passive devices 120, 130, 140, 150 using the channel frequency response (H_{ck}) for each path. In some examples, the 3D localization circuitry 210 uses the adaptive distance measurement circuitry 240 to determine which of the model parameters 270 to use when implementing the modeling circuitry 250. For example, if the quality metric (Q3) is greater than a threshold, the adaptive distance measurement circuitry 240 uses a portion of the model parameters 270 to implement the modeling circuitry 250 as a non-line of sight model. In such examples, the non-line of sight model of the modeling circuitry 250 is a ML/AI model trained to determine a range from the channel frequency response (H_{ck}) when the path has an obstruction. In another example, if the quality metric (Q3) is less than a threshold, the adaptive distance measurement circuitry 240 uses a portion of the model parameters 270 to implement the modeling circuitry 250 as a line-of-sight model. In such examples, the line-of-sight model of the modeling circuitry 250 is a ML/AI model trained to determine a range from the channel frequency response (H_{ck}) when the path is unobstructed. Also, the adaptive distance measurement circuitry 240 may also determine the distance between the initiator device 110 and the reflector device using the channel frequency response (Hₐ).

Additionally, in some examples, the programmable circuitry 270 determines the range of the reflector location from the initiator location using the determined channel frequency response (Hₐ). Similar to the channel frequency response (H_{ck}) for paths between the passive devices 120, 130, 140, 150 and the reflector device 170, the modeling circuitry 250 may provide a range between the initiator device 110 and the reflector device 170 responsive to a determination of the channel frequency response (Hₐ). In such examples, the local offset of the initiator device 110 and the reflector device 170 cancel and the phase shift is proportional to the time of flight (τ). Advantageously, the two-way signaling between the initiator device 110 and the reflector device 170 provide a phase shift representing the distance between the initiator location and the reflector location.

The 3D localization circuitry 210 localizes the reflector location using the range(s). (Block 455). In some examples, the 3D localization circuitry 210 uses the ranges from the channel frequency responses (Hₐ, H_{ck}) to determine the location of the reflector device. In some examples, the modeling circuitry 250 implements a trained ML/AI model to determine the range and/or location of the reflector device 170 from the channel frequency responses (Hₐ, H_{ck}). In other examples, the 3D localization circuitry 210 uses the localization logic 260 to determine the location of the reflector device 170 using the ranges from the modeling circuitry 250.

Control proceeds to return to the operations 500 of FIG. 5. Example methods are described with reference to the flowchart illustrated in FIG. 4. However, many other methods of implementing the passive signaling circuitry 180 of FIGS. 1, 2, and 3 and the 3D localization circuitry 210 of FIG. 2 or, more generally, the communication system 100 of FIG. 1 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 5 is a flowchart representative of example machine-readable instructions or example operations 500 that may be at least one of executed, instantiated, or performed using an example implementation of the passive signaling circuitry 180 of FIGS. 1, 2, and 3 and the 3D localization circuitry 210 of FIG. 2 or, more generally, the communication system 100 of FIG. 1 to calibrate channel sounding for multi-path components. The example operations 500 of FIG. 5 begin at Block 505 at which, the passive CFR circuitry 330 determines if calibration characteristics are available. In example operations, the passive CFR circuitry 330 determines whether the measurements 385, 390 (PCT_{IK,0}, PCT_{KI,0}) are available. For example, passive CFR circuitry 330 checks the datastore 325 for the measurements 385, 390 (PCT_{IK,0}, PCT_{KI,0}). In such example operations, the measurements 385, 390 (PCT_{IK,0}, PCT_{KI,0}) are available in the datastore 325 after calibration operations.

If the passive CFR circuitry 330 determines that calibration characteristics are available (e.g., Block 505 returns a result of YES), the calibration check circuitry 350 determines if a calibration interval has occurred. (Block 510). In example operations, the calibration check circuitry 350 uses the timer circuitry 345 to periodically perform calibration operations. In some examples, the calibration check circuitry 350 also checks a state of the communication system 100 before starting a periodic calibration. For example, the calibration check circuitry 350 checks network traffic of the communication system 100 prior to periodically calibrating. In such examples, during relatively high network traffic conditions, the calibration check circuitry 350 delay or skip periodic calibration operations.

If the calibration check circuitry 350 determines the calibration interval has not occurred (e.g., Block 510 returns a result of NO), the calibration interrupt circuitry 355 determines if there is a calibration interrupt. (Block 515). In example operations, the calibration interrupt circuitry 355 implements an interrupt service routine to generate a calibration interrupt responsive to a user defined function. For example, if the calibration interrupt circuitry 355 implements temperature monitoring, the calibration interrupt circuitry can generate calibration interrupts responsive to changes in temperature.

If the calibration interrupt circuitry 355 determines there is no calibration interrupt (e.g., Block 515 returns a result of NO), the CFR power circuitry 335 determines a CFR power metric using the current calibration characteristics and the characteristics of the received localization signal at the passive location(s). (Block 520). In example operations, the CFR power circuitry 335 uses Equation (12) and the measurements 375, 385 (PCT_{IK}, PCT_{IK,0}) to determine the metric (Q). The metric (Q) is a ratio representing a difference between the amplitude of the measurements 375 (PCT_{IK}), which are received during localization operations, and the measurements 385 (PCT_{IK,0}), which are received during calibration operations. In such example operations, the metric (Q) increases responsive to changes in the communication environment. Advantageously, the metric (Q) represents changes in the communication environment between calibration and localization operations.

The threshold circuitry 335 determines if the CFR power metric is greater than a threshold. (Block 525). In example operations, the threshold circuitry 335 compares the metric (Q) to a threshold. The threshold represents an acceptable amount of change in a communication environment between the most recent calibration operations and current localization operations. If the threshold circuitry 335 determines that the CFR power metric is less than the threshold (e.g., Block 525 returns a result of NO), control proceeds to return. In such example operations, if the metric (Q) is less than the threshold, the threshold circuitry 335 determines that an acceptable change in the communication environment has occurred.

If the passive CFR circuitry 330 determines the calibration characteristics are not available (e.g., Block 505 returns a result of NO), the calibration check circuitry 350 determines that the calibration interval has not occurred (e.g., Block 510 returns a result of YES), the calibration interrupt circuitry 355 detects a calibration interrupt (e.g., Block 515 returns a result of YES), or the threshold circuitry 340 determines the CFR power metric is greater than a threshold (e.g., Block 525 returns a result of YES), the initial device 110 transmits a calibration signal at the initial location. (Block 530). In example operations, the initiator device 110 begins calibration operations by transmitting a calibration signal. In some examples, the initiator device 110 sets a magnitude, phase, and frequency of the calibration signal based on a specific signaling process. For example, in some examples, the initiator device 110 adjusts the frequency of the calibration signal after each calibration or localization operation. Such example frequency adjustments of the calibration signal are referred to as channel hopping. In such examples, the initiator device 110 rotates between the seventy-five BLE channels by adjusting the calibration signal by one megahertz after each localization operation.

At least one of the passive devices 120, 130, 140, 150 receive the calibration signal at the passive location(s). (Block 535). In example operations, the calibration signal propagates through the communication environment to the passive devices 120, 130, 140, 150. During propagation, characteristics of the communication environment and the signal path modify characteristics of the calibration signal. For example, the time of flight (τ) adds a phase shift to the calibration signal. In such example operations, at least one of the passive devices 120, 130, 140, 150 receive the calibration signal from the initiator device 110.

The initiator-passive signaling circuitry 305 characterizes the received calibration signal at the passive location(s). (Block 540). In example calibration operations, the path between the initiator device 110 and the passive devices 120, 130, 140, 150 is characterized by a channel frequency response (H_{bk,0}) or, more generally, the measurements 385 (PCT_{IK,0}). The measurements 385 (PCT_{IK,0}) represent the channel frequency response (H_{bk,0}) of the paths between the initiator device 110 and the passive devices 120, 130, 140, 150. For example, the channel frequency response (H_{bk,0}) for a path between the initiator device 110 and the passive devices 120, 130, 140, 150 can be determined using Equation (1), the measurements 385 (PCT_{IK,0}), and the local phase offset. In such example operations, the initiator-passive signaling circuitry 305 produces the measurements 385 (PCT_{IK,0}) using magnitude, frequency, and phase of the calibration signal received by at least one of the passive devices 120, 130, 140, 150.

The at least one of the passive devices 120, 130, 140, 150 reflect the calibration signal at the passive location(s). (Block 545). In example operations, the one of the passive devices 120, 130, 140, 150 that received the calibration signal transmits a reflected calibration signal. The reflected calibration signal has characteristics matching the received calibration signal. In some examples, only one of the passive devices 120, 130, 140, 150 reflect the received calibration signal to reduce interference. In such examples, a different set of the measurements 385, 390 (PCT_{IK,0}, PCT_{IK,0}) are collected for each of the passive devices 120, 130, 140, 150.

The initiator device 110 receives the reflected calibration signal at the initial location. (Block 550). In example operations, the reflected calibration signal propagates through the communication environment to the initiator device 110. In example operations, the initiator device 110 receives the reflected calibration signal from at least one of the passive devices 120, 130, 140, 150.

The passive-initiator signaling circuitry 310 characterizes the reflected calibration signal at the initial location. (Block 555). In example operations, the paths between the initiator device 110 and the passive devices 120, 130, 140, 150 are characterized by a channel frequency response (H_{bk,0}) or, more generally, the measurement 390 (PCT_{KI,0}). The measurement 390 (PCT_{KI,0}) represents the channel frequency response (H_{bk,0}) of the paths between the initiator device 110 and the passive devices 120, 130, 140, 150. In such example operations, the passive-initiator signaling circuitry 310 produces the measurement 390 (PCT_{KI,0}) using magnitude, frequency, and phase of the reflected localization signal received by the initiator device 110. Advantageously, the measurement 390 (PCT_{KI,0}) represents two-way signaling along the signal path between the initiator device 110 and the passive devices 120, 130, 140, 150.

The initiator-passive signaling circuitry 305 determines if a calibration signal has been used for each passive device. (Block 560). In some example operations, only one of the passive devices 120, 130, 140, 150 are structured to reflect a given calibration signal. In such example operations, the initiator-passive signaling circuitry 305 uses a plurality of calibration signals to receive a set of the measurements 385, 390 (PCT_{IK,0}, PCT_{IK,0}) for each of the passive devices 120, 130, 140, 150. If the initiator-passive signaling circuitry 305 determines that not all of the passive devices have been characterized by separate calibration signals (e.g., Block 560 returns a result of NO), control proceeds to return to Block 530 to determine characteristics between the initiator and another passive device. Advantageously, using individual calibration signals for each of the passive devices 120, 130, 140, 150 reduces noise from multiple reflected calibration signals.

If the initiator-passive signaling circuitry 305 determines that all of the passive devices have been characterized by separate calibration signals (e.g., Block 560 returns a result of YES), the signaling circuitry 305, 310 set the characteristics of the received calibration signal and the reflected calibration signal as the calibration characteristics for each passive device. (Block 565). In example operations, the signaling circuitry 305, 310 store the measurements 385, 390 (PCT_{IK,0}, PCT_{IK,0}) for each path between the initiator device 110 and the passive devices 120, 130, 140, 150 in the datastore 325.

Control proceeds to return. Example methods are described with reference to the flowchart illustrated in FIG. 5. However, many other methods of implementing the passive signaling circuitry 180 of FIGS. 1, 2, and 3 and the 3D localization circuitry 210 of FIG. 2 or, more generally, the communication system 100 of FIG. 1 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

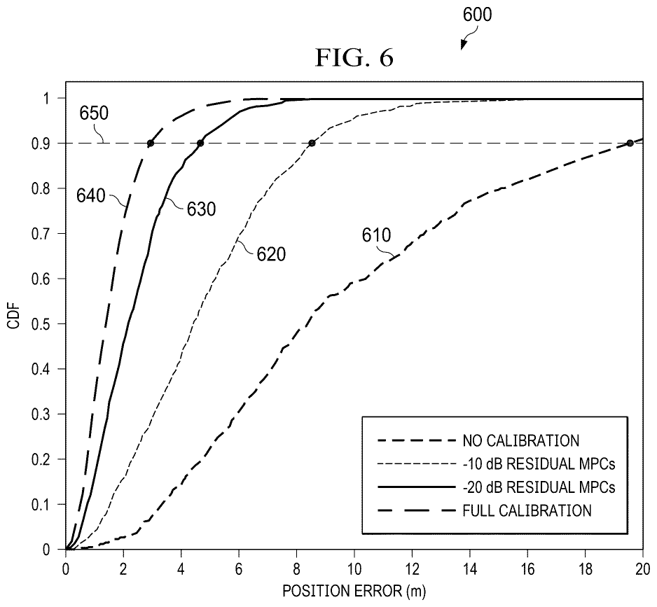

FIG. 6 is a plot 600 of example performance of the localization of the reflector device 170 of FIGS. 1 and 2 using the initiator device 110 and the passive devices 120, 130, 140, 150 of FIGS. 1 and 2 in a first environment. In the example of FIG. 6, the plot 600 illustrates uncalibrated performance 610, first multi-path calibration (MPC) performance 620, second MPC performance 630, and full MPC performance 640 in a first simulated communication environment. In the example of FIG. 6, the simulated communication environment is an indoor office or commercial space.

In the example of FIG. 6, the uncalibrated performance 610 represents a position error of localization operations of the communication system 100 without the passive signaling circuitry 180 as a cumulative distribution function (CDF). Specifically, the uncalibrated performance 610 represents the CDF of the position error of localization when the channel frequency response (H_{bk,e}) of the paths between the initiator device 110 and the passive devices 120, 130, 140, 150 are empirically calculated. For example, the phase shift of the channel frequency response (H_{bk,e}) is estimated using a known distance (d_{bk}) between the initiator device 110 and the passive devices 120, 130, 140, 150 divided by the speed of light (C). However, estimating the channel frequency response (H_{bk,e}) using fixed values fails to account for the multi-path components at the passive devices 120, 130, 140, 150. For example, if the estimate of the channel frequency response (H_{bk,e}) is used in place of the calibration channel frequency response (H_{bk,0}) in Equations (7)-(10), the multi-path components of the channel frequency response (H_{bk}) received during localization are not canceled.

Advantageously, the measurements used to receive the channel frequency response (H_{bk,0}) include multi-path components similar to the multi-path components of the channel frequency response (H_{bk}) received during localization operations. Advantageously, as illustrated by Equation (10), the multi-path components common to both of the channel frequency responses (H_{bk,0}, H_{bk}) cancel. Advantageously, using the channel frequency response (H_{bk,0}) received during calibration operations to determine the channel frequency response (H_{CK}) between the reflector device 170 and the passive devices 120, 130, 140, 150 reduces multi-path components.

In the example of FIG. 6, the MPC performances 620, 630, 640 represent the position error of localization operations of the communication system 100 with the passive signaling circuitry 180 as a CDF. The MPC performance 620 represents the CDF of position error of localization operations when the channel frequency responses (H_{bk,0}, H_{bk}) have approximately −10 decibels (dB) of residual multi-path components. For example, if the multi-path components of the communication environment changed by −10 decibels (dB) between calibration and localization operations. Similarly, the MPC performance 630 represents the CDF of position error of localization operations when the channel frequency responses (H_{bk,0}, H_{bk}) have approximately −30 decibels (dB) of residual multi-path components. For example, if the multi-path components of the communication environment changed by −30 decibels (dB) between calibration and localization operations.

The MPC performance 640 represents the CDF of position error of localization operations when the channel frequency responses (H_{bk,0}, H_{bk}) have approximately zero residual multi-path components. For example, if the multi-path components of the communication environment did not change between calibration and localization operations.

In the example operations of the plot 600, the error of locating the reflector device 170 decreases as the residual multi-path component decreases. For example, at a threshold CDR 650, the uncalibrated performance 610 has an error of approximately 19 meters and the MPC performance 640 has an error of approximately 3 meters. In some examples, adjusting the periodic interval of the timer circuitry 345 or the threshold of the threshold circuitry 340

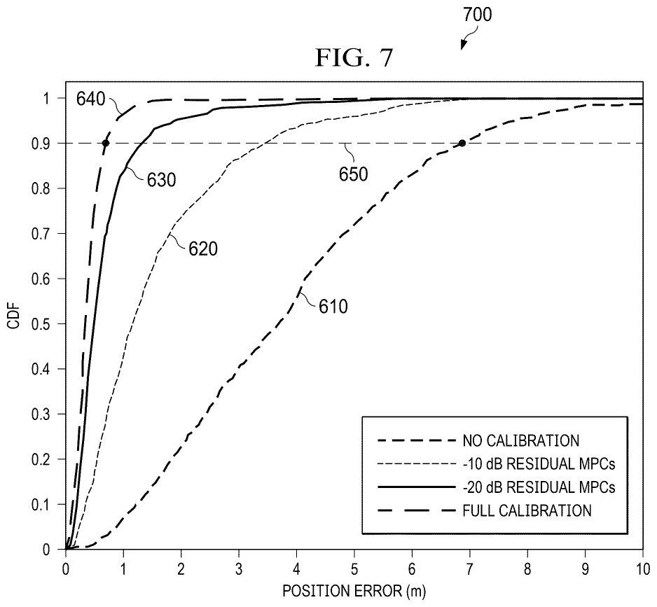

FIG. 7 is a plot 700 of example performance of the localization of the reflector device 170 of FIGS. 1 and 2 using the initiator device 110 and the passive devices 120, 130, 140, 150 of FIGS. 1 and 2 in a second environment. In the example of FIG. 7, the plot 700 illustrates uncalibrated performance 610 and the MPC performances 620, 630, 640 in a second simulated communication environment. Unlike the simulated communication environment of FIG. 6, the simulated communication environment of FIG. 7 is an indoor residential space, such as a house. Advantageously, using the passive signaling circuitry 180 and the measurements 385, 390 (PCT_{IK,0}, PCT_{IK,0}) reduces multi-path component t during localization operations. Advantageously, reducing multi-path components during localization operations improves the accuracy of the location of the reflector device 170.

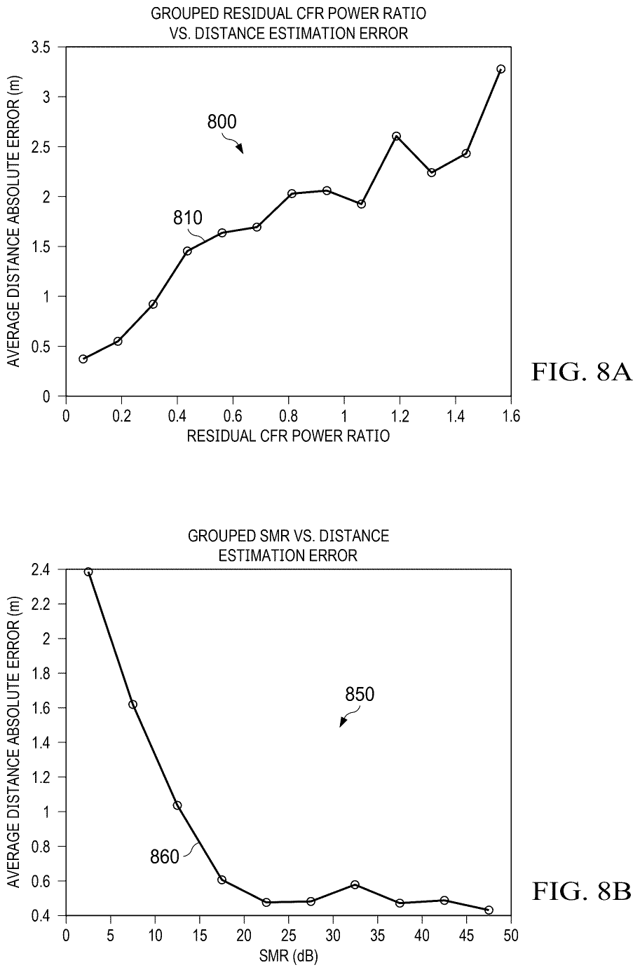

FIG. 8A is a plot 800 of example performance of the passive signaling circuitry 180 of FIGS. 1, 2, and 3 and the 3D localization circuitry 210 of FIG. 2. In the example of FIG. 8A, the plot 800 illustrates an example error 810 across different CFR power ratios. The error 810 plots the error in a determined position of the reflector device 170 as the CFR power ratio increases. In example operations, the CFR power circuitry 335 uses the measurements 375, 385 (PCT_{IK}, PCT_{IK,0}) and Equation (12) to determine the metric (Q), which represents the CFR power ratio. Advantageously, as illustrated in the plot 800, the error 810 increases as the metric (Q) increases. Advantageously, setting the threshold of the threshold circuitry 340 reduces the maximum CFR power ratio between calibration operations.

FIG. 8B is a plot 850 of example performance of the passive signaling circuitry 180 of FIGS. 1, 2, and 3 and the 3D localization circuitry 210 of FIG. 2. In the example of FIG. 8A, the plot 800 illustrates an example error 860 across different signal to residual multipath power ratios (SMR). The SMR is a ratio of the magnitude of the localization signal to the magnitude of the residual multi-path components, such as the difference between multi-path components of the channel frequency responses (H_{bk,0}, H_{bk}). Advantageously, the error 860 between the determined and actual location of the reflector device 170 decreases with the residual multi-path components. Advantageously, reducing the residual multi-path components between the channel frequency responses (H_{bk,0}, H_{bk}) increases the accuracy of the localization operations.

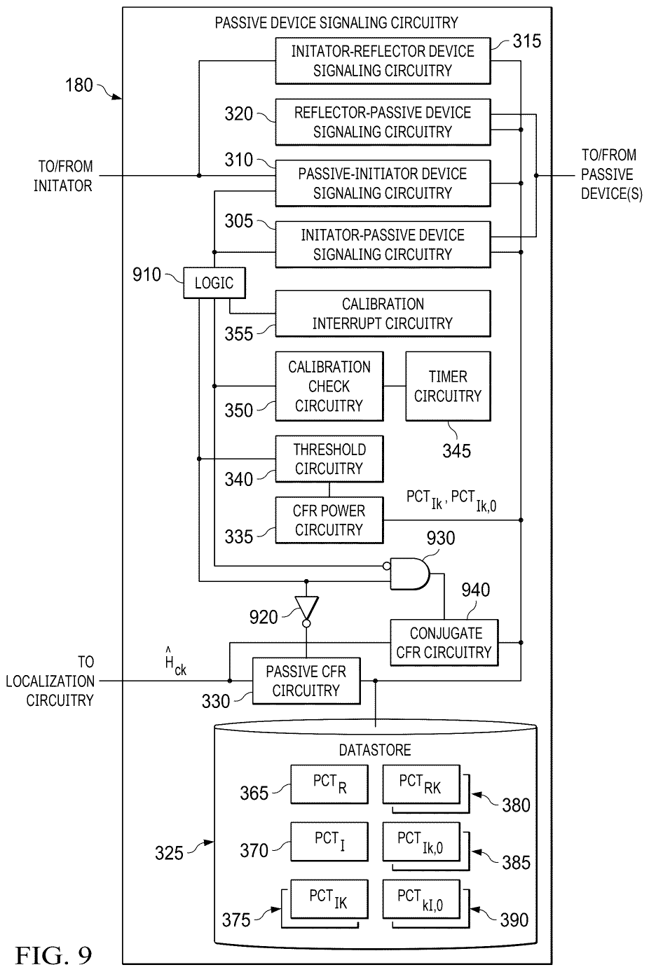

FIG. 9 is a block diagram of an example implementation of the passive signaling circuitry 180 of FIGS. 1 and 2 to determine characteristics of signals, which includes magnitude, reflected by the reflector device 170 and received by the passive devices 120, 130, 140, 150. The passive signaling circuitry 180 of FIG. 9 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the passive signaling circuitry 180 of FIG. 9 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 9 may, thus, be instantiated at the same or different times. Some or all of the circuitry of FIG. 9 may be instantiated, for example, in one or more threads executing concurrently on hardware or in series on hardware. Moreover, in some examples, some or all of the circuitry of FIG. 9 may be implemented by microprocessor circuitry executing instructions or FPGA circuitry performing operations to implement one or more virtual machines or containers.

The passive signaling circuitry 180 is structured to be coupled to the devices 110, 120, 130, 140, 150. The example passive signaling circuitry 180 of FIG. 9 includes the initiator-passive signaling circuitry 305, the passive-initiator signaling circuitry 310, the initiator-reflector signaling circuitry 315, the reflector-passive signaling circuitry 320, the datastore 325, the passive CFR circuitry 330, the CFR power circuitry 335, the threshold circuitry 340, the timer circuitry 345, the calibration check circuitry 350, the calibration interrupt circuitry 355, logic circuitry 910, an inverter 920, a logic device 930, and conjugate CFR circuitry 940. The passive signaling circuitry 180 uses calibration and localization operations of the communication systems 100, 200 to determine the channel frequency response (H_{ck}) between the initiator device 110 and any of the passive devices 120, 130, 140, 150. In some examples, the passive signaling circuitry 180 determines a channel frequency response (H_{ck}) for each of the passive devices 120, 130, 140, 150. In such examples, the 3D localization circuitry 210 determines a distance between each of the passive devices 120, 130, 140, 150 and the reflector device 170 using the plurality of channel frequency responses (H_{ck}).

The logic circuitry 910 receives the outputs of the threshold circuitry 340, the calibration check circuitry 350, and the calibration interrupt circuitry 355. Similar to the logic device 360, the logic circuitry 910 causes the signaling circuitry 305, 310 to begin calibration operations responsive to the logical combination of the received outputs. In some examples, the logic circuitry 910 uses one or more logic devices to set the conditions that initiate calibration operations. For example, the logic circuitry 910 initiates the calibration operations of the signaling circuitry 305, 310 responsive to both an indication from the threshold circuitry and the calibration check circuitry 350. In such examples, the calibration operations occur responsive to the interval set by the timer circuitry 345 and the threshold comparison of the metric of Equation (12). In some examples, the logic circuitry 910 is instantiated by ASIC or programmable circuitry executing logic instructions to perform operations such as those represented by the flowcharts of FIGS. 5 and 9. Logic circuitry 910 may be configurable to initiate calibration operations with or without a reflector device in range.

The inverter 920 receives the output of the threshold circuitry 340, which provides an indication representing a comparison of the metric (Q) to a threshold value. The inverter 920 inverts the output of the threshold circuitry 340 to control the passive CFR circuitry 330. In example operations, the inverter 920 enables the passive CFR circuitry 330 to calculate the channel frequency response (H_{CK}) using Equations (7)-(10) and the measurements 365, 370, 375, 380, 385, 390. In such example operations, the amplitudes of measurements 375, 380 substantially cancel out during the reduction of Equation (7) to Equation (10). Advantageously, such canceling reduces the amplitude of multi-path components. In some examples, inverter 920 is instantiated by ASIC or programmable circuitry executing inverter instructions to perform operations such as those represented by the flowcharts of FIGS. 5 and 9.

The logic device 930 receives the outputs of the threshold circuitry 340 and the calibration check circuitry 350. The logic device 930 controls the conjugate CFR circuitry 940 responsive to the outputs of the threshold circuitry 340 and the calibration check circuitry 350. In example operations, the logic device enables the conjugate CFR circuitry 940 to calculate the channel frequency response (H_{CK}). In such example operations, if the metric (Q) is less than the threshold value and the calibration check circuitry 350 determines no calibration is needed, the calibration check circuitry 350 the logic device 930 enables the conjugate CFR circuitry 940. In some examples, the logic device 930 is instantiated by ASIC or programmable circuitry executing logic device instructions to perform operations such as those represented by the flowcharts of FIGS. 5 and 9.

The conjugate CFR circuitry 940 receives the measurements 365, 370, 375, 380, 385, 390 from the datastore 325. The conjugate CFR circuitry 940 calculates the channel frequency response (H_{CK}) using Equation (11) and the measurements 365, 370, 375, 380, 385, 390. In such example operations, unlike in Equations (7)-(10), the conjugate CFR circuitry 940 uses the conjugate of the measurement 375 to determine the channel frequency response (H_{CK}) of paths between the initiator device 110 and the passive devices 120, 130, 140, 150. Advantageously, using the conjugate of the measurement 375 reduces the loss of amplitude data in calculating the channel frequency response (H_{CK}). In some examples, the adaptive distance measurement circuitry 240 or the modeling circuitry 250 uses amplitude data to improve the selection or implementation of a trained AI/ML model. Advantageously, the conjugate CFR circuitry 940 improves the accuracy of distance measurements and localization operations. In some examples, the conjugate CFR circuitry 940 is instantiated by ASIC or programmable circuitry executing conjugate CFR instructions to perform operations such as those represented by the flowcharts of FIGS. 5 and 9.

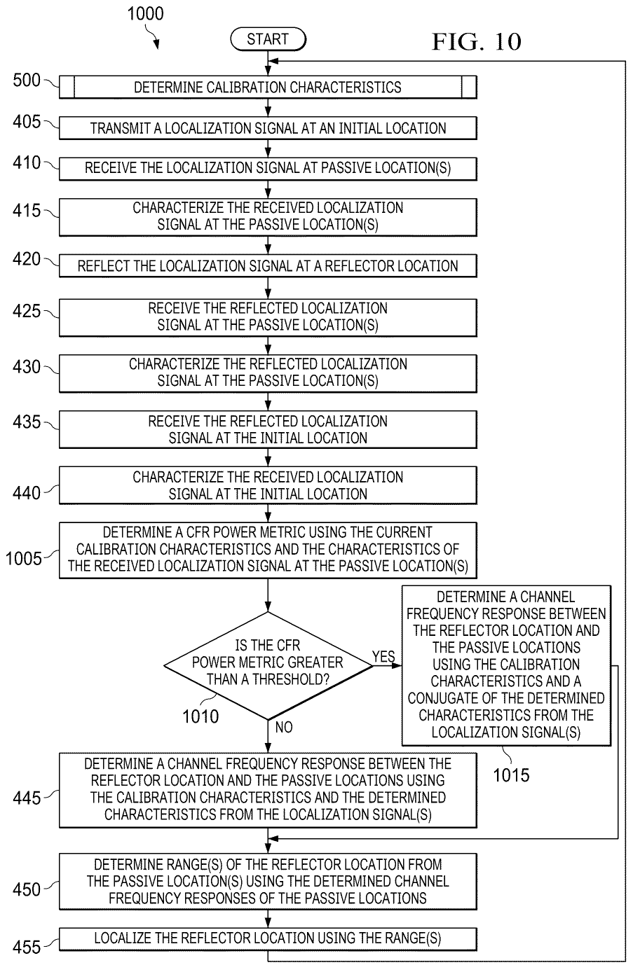

FIG. 10 is a flowchart representative of example machine-readable instructions or example operations 1000 that may be at least one of executed, instantiated, or performed using an example implementation of the passive signaling circuitry 180 of FIGS. 1, 2, and 9 and the 3D localization circuitry 210 of FIG. 2 or, more generally, the communication system 100 of FIG. 1 to locate the reflector device 170 of FIGS. 1 and 2. The example operations 1000 of FIG. 10 begin with example operations 500 of FIG. 5 at which, the passive signaling circuitry 180 determines calibration characteristics. Control proceeds to Blocks 405, 410, 415, 420, 425, 430, 435, 440.

The CFR power circuitry 335 determines a CFR power metric using the current calibration characteristics and the characteristics of the received localization signal at the passive location(s). (Block 1005). In example operations, the CFR power circuitry 335 uses Equation (12) and the measurements 375, 385 (PCT_{IK}, PCT_{IK,0}) to determine the metric (Q). The metric (Q) is a ratio representing a difference between the amplitude of the measurements 375 (PCT_{IK}), which are received during localization operations, and the measurements 385 (PCT_{IK,0}), which are received during calibration operations. In such example operations, the metric (Q) increases responsive to changes in the communication environment. Advantageously, the metric (Q) represents changes in the communication environment between calibration and localization operations.

The threshold circuitry 340 determines if the CFR power metric is greater than a threshold. (Block 1010). In example operations, the threshold circuitry 335 compares the metric (Q) to a threshold. The threshold represents an acceptable amount of change in a communication environment between the most recent calibration operations and current localization operations. If the threshold circuitry determines that the CFR power metric is not greater than the threshold (e.g., Block 1010 returns a result of NO), control proceeds to Block 445. In example operations, if the metric (Q) is less than the threshold, the threshold circuitry 335 determines that an acceptable change in the communication environment has occurred. In such example operations, the inverter 920 enables the passive CFR circuitry 330 to determine the channel frequency response (H_{CK}) using Equation (8) and the measurements 365, 370, 375, 380, 385, 390.

If the threshold circuitry 335 determines that the CFR power metric is greater than the threshold (e.g., Block 1010 returns a result of YES), the conjugate CFR circuitry 940 determines range(s) of the reflector location from the passive location(s) using a conjugate of the determined characteristics. (Block 1015). In some examples, the logic device 930 limits the conjugate CFR circuitry 940 to periods that the logic circuitry 910 is not initiating calibration operations, such as when the output of the calibration check circuitry 350 is asserted. In example operations, the channel frequency response (H_{ck}) or, more generally, the measurements 380 (PCT_{RK}) represent signal paths between the passive devices 120, 130, 140, 150 and the reflector device 170. In some examples, the conjugate CFR circuitry 940 determines the channel frequency response (H_{ck}) using Equation (11) and the measurements 365, 370, 375, 380, 385, 390. In such examples, the measurements 385, 390 (PCT_{IK,0}, PCT_{KI,0}) represent the calibration characteristics of the communication system 100. In such example operations, the conjugate CFR circuitry 940 determines the channel frequency response (H_{ck}) for the paths between the passive devices 120, 130, 140, 150 and the reflector device 170. Advantageously, using Equation (11) and the measurements 365, 370, 375, 380, 385, 390 reduces the multipath components of the channel frequency response (H_{ck}) and maintains the amplitude of the measurements 375, 380.

Control proceeds to Block 450 and return to the operations 500 of FIG. 5. Example methods are described with reference to the flowchart illustrated in FIG. 10. However, many other methods of implementing the passive signaling circuitry 180 of FIGS. 1, 2, and 9 and the 3D localization circuitry 210 of FIG. 2 or, more generally, the communication system 100 of FIG. 1 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

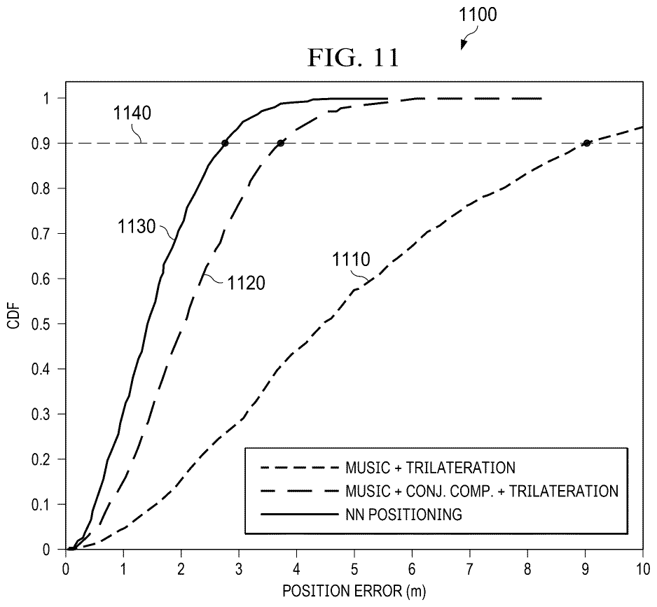

FIG. 11 is a plot 1100 of example performance of localization of the reflector device 170 of FIGS. 1 and 2 using the initiator device 110 and the passive devices 120, 130, 140, 150 of FIGS. 1 and 2 using different data models and the passive signaling circuitry 180 of FIGS. 1, 2, and 9. In the example of FIG. 11, the plot 1100 illustrates performance of a line of sight (LOS) distance model 1110, a LOS conjugate distance model 1120, and a neural network model 1130 for localizing the reflector device 170 in a communication environment.

The LOS distance model 1110 represents localization operations represents when the modeling circuitry 250 implements a MUSIC model for distance calculations and the localization logic 260 implements trilateration logic using the distances. The LOS conjugate distance model 1120 represents when the modeling circuitry 250 implements a MUSIC model for distance calculations using the channel frequency response (H_{ck}) from the conjugate CFR circuitry 940, which maintains the amplitudes. Also, the LOS conjugate distance model 1120 uses the localization logic 260 to localize the reflector device 170 using the distances from the modeling circuitry 250. The neural network model 1130 is a type of trained AI model that has been trained to perform both distance and localization operations using the channel frequency responses (H_{ck}) of signal paths between the initiator device 110 and the passive devices 120, 130, 140, 150.

Advantageously, the conjugate CFR circuitry 940 improves the performance of the LOS distance model 1110 by preserving the amplitude in the channel frequency response (H_{ck}). For example, at an example threshold CDR 1140, the position error of the LOS conjugate distance model 1120 is more accurate by approximately six meters. Advantageously, in resource constrained systems, the LOS conjugate distance model 1120 provides performance comparable to the neural network model 1130.

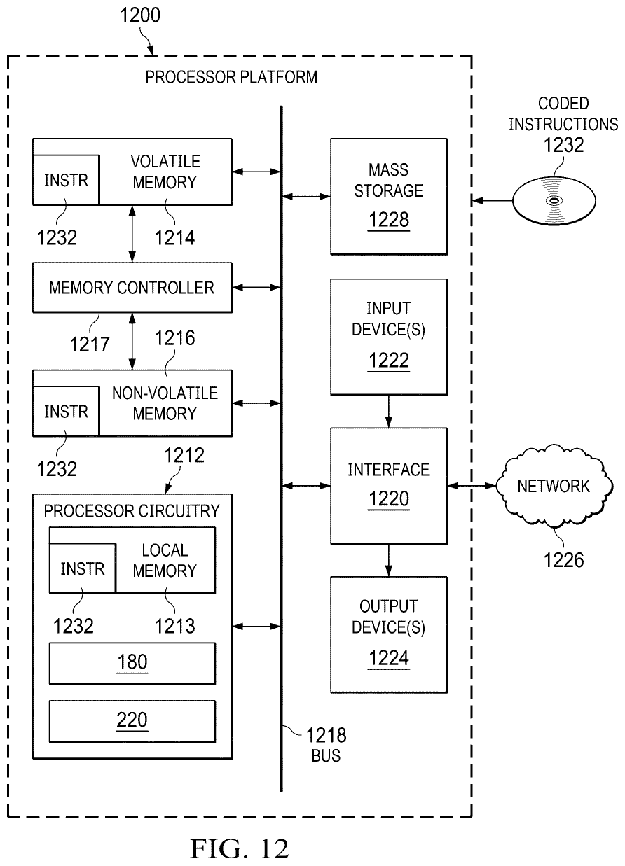

FIG. 12 is a block diagram of an example programmable circuitry platform 1200 structured to one or a combination of execute or instantiate one or more of the example machine-readable instructions or the example operations of FIGS. 4, 5, and 10 to implement the passive signaling circuitry and the 3D localization circuitry of FIGS. 2, 3, and 9. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, or microcontrollers from any desired family or manufacturer. The programmable circuitry 1212 may be implemented by one or more semiconductor based (e.g., silicon based) devices. In this example, the programmable circuitry 1212 implements the passive signaling circuitry 180 and the 3D localization circuitry 210.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1216 may be implemented by one or a combination of flash memory or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter one of or a combination of data or commands into the programmable circuitry 1212. The input device(s) 1222 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1224 are also connected to the interface circuitry 1220 of the illustrated example. The output device(s) 1224 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1220 of the illustrated example, thus, includes one of or a combination of a graphics driver card, a graphics driver chip, or graphics processor circuitry such as a GPU.

The interface circuitry 1220 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store one or more of firmware, software, or data. Examples of such mass storage discs or devices 1228 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1232, which may be implemented by the machine-readable instructions of FIGS. 4, 5, and 10, may be stored in one of or a combination of the mass storage device 1228, in the volatile memory 1214, in the non-volatile memory 1216, or on at least one non-transitory computer readable storage medium such as a CD or DVD which may be removable.

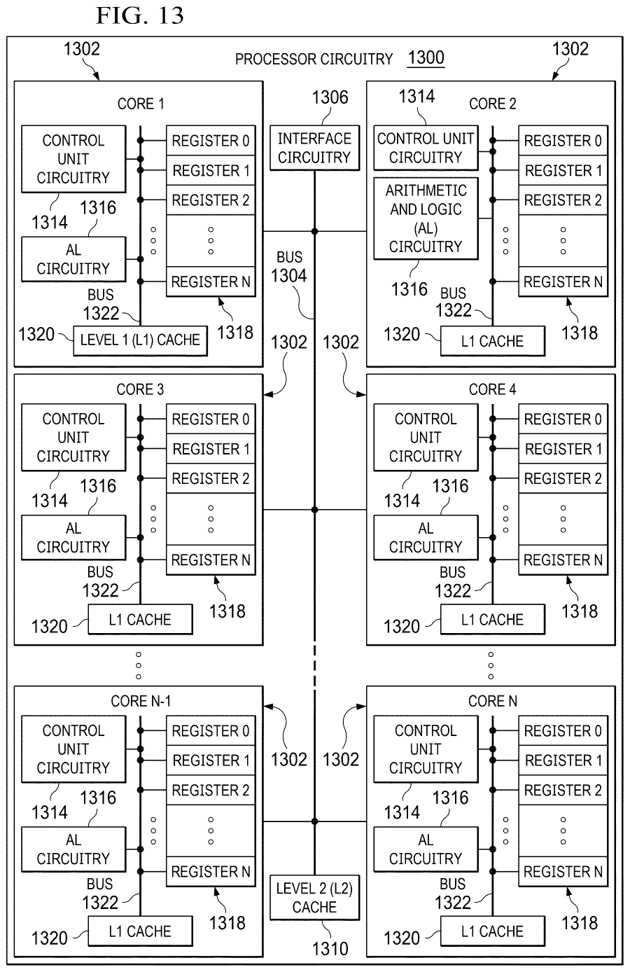

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 4, 5, and 10 to effectively instantiate the circuitry of FIGS. 2, 3, and 9 as logic circuits to perform operations corresponding to those machine-readable instructions. In some such examples, the circuitry of FIGS. 2, 3, and 9 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine-readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine-readable instructions or operations represented by the flowcharts of FIGS. 4, 5, and 10.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Also or alternatively, the first bus 1304 may be implemented by any other type of computing or electrical bus. The cores 1302 may receive data, instructions, and signals from one or more external devices by example interface circuitry 1306. The cores 1302 may output data, instructions, and signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and instructions. Data and instructions may be transferred (e.g., shared) by one of or a combination of writing to or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). In some examples, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic or logic operations on the data within the corresponding core 1302. The AL circuitry 1316 of some examples performs integer based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 or, more generally, the microprocessor 1300 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 1300 is a semiconductor device fabricated to include many transistors interconnected to implement the structures described above in one or more integrated circuits (ICs) contained in one or more packages.

The microprocessor 1300 may include or cooperate with one or more accelerators (e.g., acceleration circuitry, hardware accelerators, etc.). In some examples, accelerators are implemented by logic circuitry to perform certain tasks more quickly and efficiently than can be done by a general-purpose processor. Examples of accelerators include ASICs and FPGAs such as those described herein. A GPU, DSP, or other programmable device can also be an accelerator. Accelerators may be on-board the microprocessor 1300, in the same chip package as the microprocessor 1300, or in one or more separate packages from the microprocessor 1300.

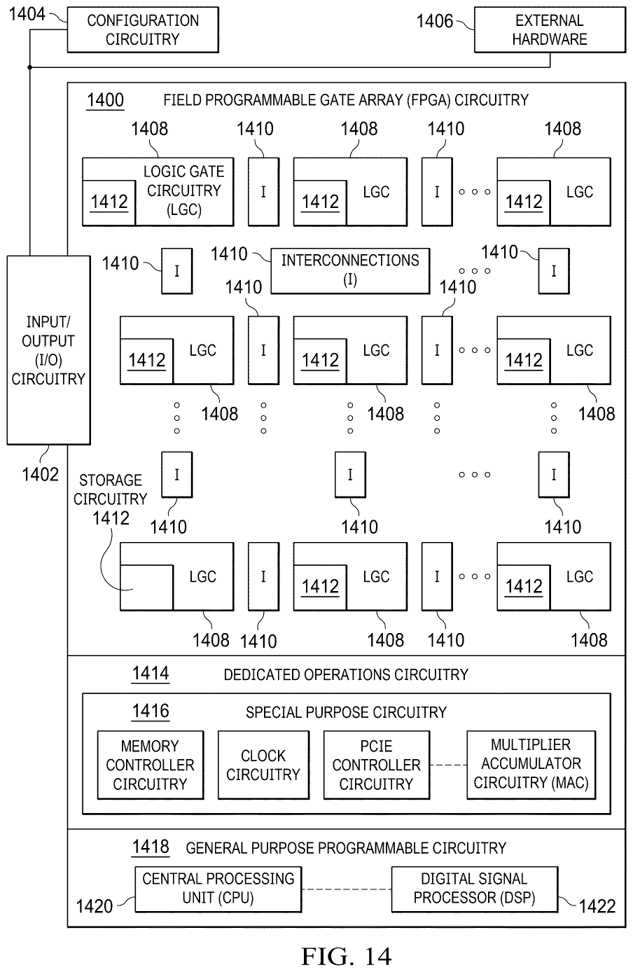

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine-readable instructions. However, once configured, the FPGA circuitry 1400 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine-readable instructions represented by the flowchart(s) of FIGS. 4, 5, and 10 but whose interconnections and logic circuitry are fixed once fabricated), the FPGA circuitry 1400 of the example of FIG. 14 includes interconnections and logic circuitry that may be one of or a combination of configured, structured, programmed, and interconnected in different ways after fabrication to instantiate, for example, some or all of the operations/functions corresponding to the machine-readable instructions represented by the flowchart(s) of FIGS. 4, 5, and 10. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4, 5, and 10. As such, the FPGA circuitry 1400 may be at least one of configured or structured to effectively instantiate some or all of the operations/functions corresponding to the machine-readable instructions of the flowchart(s) of FIGS. 4, 5, and 10 as dedicated logic circuits to perform the operations/functions corresponding to those software instructions in a dedicated manner analogous to an ASIC. Therefore, the FPGA circuitry 1400 may perform the operations/functions corresponding to the some or all of the machine-readable instructions of FIGS. 4, 5, and 10 faster than the general-purpose microprocessor can execute the same.

In the example of FIG. 14, the FPGA circuitry 1400 is at least one of configured or structured in response to being programmed (and/or reprogrammed one or more times) based on a binary file. In some examples, the binary file may be one of or both of compiled or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may at least one of access or load the binary file to cause the FPGA circuitry 1400 of FIG. 14 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1400 of FIG. 14 to at least one of configure or structure the FPGA circuitry 1400 of FIG. 14, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 1400 of FIG. 14 may at least one of access or load the binary file to cause the FPGA circuitry 1400 of FIG. 14 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1400 of FIG. 14 to at least one of configure or structure the FPGA circuitry 1400 of FIG. 14, or portion(s) thereof.

The FPGA circuitry 1400 of FIG. 14, includes example input/output (I/O) circuitry 1402 to at least one of receive or output data to/from at least one of example configuration circuitry 1404 or external hardware 1406. For example, the configuration circuitry 1404 may be implemented by interface circuitry that may receive a binary file, which may be implemented by one or more of a bit stream, data, or machine-readable instructions, to configure the FPGA circuitry 1400, or portion(s) thereof. In some such examples, the configuration circuitry 1404 may receive the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine-readable instructions of FIGS. 4, 5, and 10 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of one of or a combination of the electrical structures or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 or an example DSP 1422. Other general purpose programmable circuitry 1418 may also or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 13. Therefore, the programmable circuitry 1212 of FIG. 12 may also be implemented by combining at least the example microprocessor 1300 of FIG. 13 and the example FPGA circuitry 1400 of FIG. 14. In some such hybrid examples, one or more cores 1302 of FIG. 13 may execute a first portion of the machine-readable instructions represented by the flowchart(s) of FIGS. 4, 5, and 10 to perform first operation(s)/function(s), the FPGA circuitry 1400 of FIG. 14 may be at least one of configured or structured to perform second operation(s)/function(s) corresponding to a second portion of the machine-readable instructions represented by the flowcharts of FIGS. 4, 5, and 10, and/or an ASIC may be at least one of configured or structured to perform third operation(s)/function(s) corresponding to a third portion of the machine-readable instructions represented by the flowcharts of FIGS. 4, 5, and 10.

Some or all of the circuitry of FIGS. 2, 3, and 9 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be at least one of configured or structured to perform operations/functions corresponding to portion(s) of machine-readable instructions at the same and/or different times.

In some examples, some or all of the circuitry of FIGS. 2, 3, and 9 may be instantiated, for example, in one or more threads executing concurrently and/or in series. For example, the microprocessor 1300 of FIG. 13 may execute machine-readable instructions in one or more threads executing concurrently and/or in series. In some examples, the FPGA circuitry 1400 of FIG. 14 may be at least one of configured or structured to carry out operations/functions concurrently and/or in series. Moreover, in some examples, some or all of the circuitry of FIGS. 2, 3, and 9 may be implemented within one or more virtual machines or containers executing on the microprocessor 1300 of FIG. 13.

In some examples, the programmable circuitry 1212 of FIG. 12 may be in one or more packages. For example, at least one of the microprocessor 1300 of FIG. 13 or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

While an example manner of implementing the passive signaling circuitry 180 or the 3D localization circuitry 210 is illustrated in FIGS. 2, 3, and 9, one or more of the elements, processes, or devices illustrated in FIGS. 2, 3, and 9 may be combined, divided, re-arranged, omitted, eliminated, or implemented in any other way. Further, the passive signaling circuitry 180 and the 3D localization circuitry 210, may be implemented by hardware alone or by hardware in combination with software and firmware. Thus, for example, any of the passive signaling circuitry 180 and the 3D localization circuitry 210, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example passive signaling circuitry and the 3D localization circuitry of FIGS. 2, 3, and 9 may include one or more elements, processes, or devices in addition to, or instead of, those illustrated in FIGS. 2, 3, and 9, or may include more than one of any or all of the illustrated elements, processes and devices.

Flowchart(s) representative of example machine-readable instructions, which may be executed by programmable circuitry to at least one of implement or instantiate the passive signaling circuitry 180 and the 3D localization circuitry 210 of FIGS. 2, 3, and 9 or representative of example operations which may be performed by programmable circuitry to at least one of implement or instantiate the passive signaling circuitry 180 and the 3D localization circuitry 210 of FIGS. 2, 3, and 9, are shown in FIGS. 4, 5, and 10. The machine-readable instructions may be one or more executable programs or portion(s) of one or more executable programs for execution by programmable circuitry such as the programmable circuitry 1212 shown in the example processor platform 1200 described below in connection with FIG. 12 and may be one or more function(s) or portion(s) of functions to be performed by the example programmable circuitry (e.g., an FPGA) described below in connection with FIG. 13 or 14. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4, 5, and 10, many other methods of implementing the example passive signaling circuitry 180 and the 3D localization circuitry 210 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include one or more CPUs and/or one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., or any combination(s) thereof in any of the contexts described above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 4, 5, and 10 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

What is claimed is:

1. An apparatus comprising:
an initiator device configurable to:
transmit a calibration signal;
receive a reflected calibration signal from a first location, the reflected calibration signal including multipath components; and
transmit a localization signal; and
programmable circuitry coupled to the initiator device, the programmable circuitry configurable to:
determine characteristics of the reflected calibration signal; and
reduce the multipath components of a reflected localization signal from a second location received at the first location using the characteristics of the reflected calibration signal received by the initiator device, wherein the reflected localization signal is a reflection of the localization signal.

2. The apparatus of claim 1, wherein the apparatus further comprises a passive device positioned at the first location, the passive device configurable to:
receive the calibration signal; and
after receiving the calibration signal, transmit the reflected calibration signal.

3. The apparatus of claim 2, wherein the programmable circuitry is coupled to the passive device, and the programmable circuitry is further configurable to:
determine characteristics of the calibration signal received at the first location;
determine a distance between the initiator device and the first location using a time of flight of the reflected calibration signal received by the initiator device; and
reduce the multipath components of the reflected localization signal using the characteristics of the calibration signal received at the first location and the reflected calibration signal received by the initiator device.

4. The apparatus of claim 1, further comprising:
a passive device configured to:
receive the calibration signal; and
receive the localization signal;
the programmable circuitry is further configurable to:
determine characteristics of the localization signal received at the passive device;
compare magnitudes of the calibration signal received at the passive device and the localization signal received at the passive device; and
detect a change in a communication environment based on the comparison of the magnitudes.

5. The apparatus of claim 4, wherein the calibration signal is a first calibration signal, and the initiator device is further configurable to after detecting the change in the communication environment, transmit a second calibration signal.

6. The apparatus of claim 1, wherein the initiator device is further configurable to periodically transmit the calibration signal.

7. The apparatus of claim 1,
wherein the initiator device is further configurable to receive the reflected localization signal,
wherein the reflected localization signal received by the initiator device has a phase offset, and
wherein the phase offset represents a distance between the initiator device and the second location.

8. The apparatus of claim 1, wherein a reflector device is at the second location, and wherein the reflector device is configurable to:
receive the localization signal; and
after receiving the localization signal, transmit the reflected localization signal.

9. The apparatus of claim 8, wherein the programmable circuitry is further configurable to:
determine characteristics of the reflected localization signal received by the initiator device;
determine characteristics of the localization signal received by the reflector device; and
determine characteristics of the reflected localization signal received at the first location using the characteristics of the reflected calibration signal received by the initiator device and the characteristics of the localization signal received by the reflector device.

10. The apparatus of claim 1, wherein the programmable circuitry is further configurable to:
determine characteristics of the reflected localization signal received by the initiator device;
determine characteristics of the localization signal received at the first location; and
determine characteristics of the reflected localization signal received at the first location using a conjugate of the localization signal received at the first location.

11. The apparatus of claim 1, wherein the programmable circuitry is further configurable to locate the second location using an artificial intelligence (AI) model and the characteristics of the reflected localization signal received by the initiator device and at the first location.

12. A method comprising:
transmitting a calibration signal from a first location;
determining characteristics of the calibration signal received at a second location, the characteristics of the calibration signal received at the second location including multipath components;
transmitting a reflected calibration signal from the second location, the reflected calibration signal is a reflection of the calibration signal;
determining characteristics of the reflected calibration signal received at the first location, the characteristics of the reflected calibration signal received at the first location including multipath components; and
reducing the multipath components of a reflected localization signal from a third location and received at the second location using the characteristics of the calibration signal received at the second location and the characteristics of the reflected calibration signal received at the first location.

13. The method of claim 12, wherein the calibration signal is a first calibration signal, the reflected calibration signal is a first reflected calibration signal, the reflected localization signal is a first reflected localization signal, the method further comprising:
transmitting a localization signal from the first location;
determining characteristics of the localization signal received at the second location;
comparing magnitudes of the calibration signal received at the second location and the localization signal received at the second location;
detecting a change in a communication environment based on the comparison of the magnitudes;
after detecting the change in the communication environment is greater than a threshold, transmitting a second calibration signal from the first location; and
reducing the multipath components of a second reflected localization signal using characteristics of the second calibration signal received at the second location and a second reflected calibration signal received at the first location.

14. The method of claim 12, further comprising:
transmitting the reflected localization signal from the third location, wherein the reflected localization signal is a reflection of a localization signal received at the third location;
determining characteristics of the reflected localization signal received at the first location;
determining characteristics of the localization signal received at the second location; and
determining characteristics of the reflected localization signal received at the second location using the characteristics of the calibration signal received at the second location and the reflected calibration signal received at the first location.

15. The method of claim 12, further comprising:
transmitting the reflected localization signal from the third location, wherein the reflected localization signal is a reflection of a localization signal received at the third location;
determining characteristics of the reflected localization signal received at the first location;
determining characteristics of the localization signal received at the second location; and
determining characteristics of the reflected localization signal received at the second location using a conjugate of the localization signal received at the second location.

16. The method of claim 12, further comprising: locating a reflector device at the third location using an artificial intelligence (AI) model and the characteristics of the reflected localization signal received at the first and second locations.

17. An apparatus comprising:
an initiator device configurable to:
transmit a calibration signal; and
receive a reflected calibration signal;
a passive device configurable to:
receive the calibration signal; and
transmit the reflected calibration signal; and
programmable circuitry coupled to the initiator device and the passive device, the programmable circuitry configurable to:
determine characteristics of the calibration signal received at the passive device, the calibration signal at the passive device having multipath components;
determine characteristics of the reflected calibration signal received at the initiator device, the reflected calibration signal including the multipath components; and
determine characteristics of a reflected localization signal received at the passive device using the characteristics of the calibration signal received at the passive device and the reflected calibration signal received at the initiator device.

18. The apparatus of claim 17, wherein the programmable circuitry is further configurable to:
determine characteristics of a localization signal received at the passive device;
compare magnitudes of the calibration signal received at the passive device and the localization signal received at the passive device; and
detect a change in a communication environment responsive to the comparison of the magnitudes.

19. The apparatus of claim 18, wherein the calibration signal is a first calibration signal, and the initiator device is further configurable to:
transmit the localization signal; and
after detecting the change in the communication environment, transmit a second calibration signal.

20. The apparatus of claim 17, wherein the initiator device is further configurable to periodically transmit the calibration signal.
